(19) United States
(12) Patent Application Publication
(10) Pub. No.: US 2026/0037050 A1
(43) Pub. Date: Feb. 5, 2026

(54) System and Method to Detect and Characterize Power Quality Issues with Multi-Tier Ai-Enabled Models

(71) Applicant: PhaseFront Inc., Cupertino, CA (US)

(72) Inventors: Mohamad Mehdi Nasr-Azadani, San Mateo, CA (US); Zaid Tashman, San Francisco, CA (US); Kevin Davies, Honolulu, HI (US); Edwin Noma, Kanagawa (JP)

(21) Appl. No.: 19/284,658

(22) Filed: Jul. 29, 2025

Related U.S. Application Data
(60) Provisional application No. 63/677,379, filed on Jul. 30, 2024.

(51) Int. Cl. G06F 1/30; G06F 1/28

(52) U.S. Cl. CPC G06F 1/305; G06F 1/28

(57) ABSTRACT

Methods, systems, and apparatus, including computer programs encoded on a computer storage medium, are configured to detect and characterize power quality issues (PQIs) by independently training artificial intelligence (AI) and machine learning (ML) models on each power quality issue and sequentially deploying them is disclosed. A multi-tier architecture includes PQI agents that are deployed reliably to monitor the power quality issues in reduced time. The multi-tier architecture includes the capability for the models to dynamically update on new data to adjust to the constantly changing conditions of the power grid. An extensible power-quality-issue-aware detection system generates data-driven anomaly scores to guide engineers and others in performing root case analysis (RCA) on power quality events associated with a facility or equipment. The system is designed for seamless integration with various power quality monitoring systems of different sensitivity or thresholds used to identify different classes of power quality issues.

### CROSS-REFERENCE TO RELATED APPLICATION

This application claims priority under 35 USC 35 USC § 119(e) to U.S. Application Ser. No. 63/677,379, entitled “AI-Enabled System to Detect and Characterize Power Quality Issues” filed on Jul. 30, 2024, the entirety of which application is herein incorporated by reference.

### BACKGROUND OF THE INVENTION

### 1. Field of the Invention

The present invention relates to the field of detecting power quality issues. In particular, the present invention relates to an intelligent power quality detection system and methods configured to detect and characterize power quality issues (“PQIs”), by independently training artificial intelligence (“AI”) and machine learning (“ML”) models on each power quality issue and sequentially deploying them. The system is structured in a multi-tier architecture with PQI agents that are deployed reliably to monitor power quality issues in reduced time and with the capability for the models to dynamically update on new data to adjust to the constantly changing conditions of the power grid.

### 2. Description of the Prior Art

Relying on power sources is critical in everyone's daily lives and the economic health of all nations. The direct and indirect consequences of power quality related disturbances are known to cost all industrial sectors substantially. The Electric Power Research Institute (EPRI) in 2022, reported that power quality related events cost industries in the United States between $145 billion and $230 billion, annually (Wright, Alden. “Societal costs of power quality disturbances.” Technical Report 3002024890, Electric Power Research Institute (EPRI), July 2022. Available at: https://www.epri.com/research/programs/053119/results/3002024890).

Several government agencies in the United States as well as the U.S. National Laboratories have periodically published (meta-) analyses and studies to share their findings of the devastating economic impact of power quality disturbances on a wide variety of segments in society. Such studies commonly attempt to estimate the cost incurred, broken down by industry type. It is well known that semiconductor industries have continuously been reported to incur the highest loss due to power quality related events or interruptions. For example, manufacturers of silicon-chip fabrication equipment typically experience voltage sags and short-term voltage interruptions (two categories of PQIs) that bear an economic cost of $350,000 per event. In silicon-chip fabrication, even an outage of a few minutes can lead to one to one-and-a-half days of downtime, resulting in substantial loss of revenue per day.

In yet another example, in the automotive manufacturing industry, a severe power quality disturbance that lasts from a few seconds to half an hour can result in a loss of up to a million dollars, and a disturbance that lasts more than an hour can cause a loss in the millions.

Yet another real-life example, involving a financial clearinghouse resulted in an economic loss of $12,000,000 for a mere thirty minutes of downtime resulting from a lightning strike.

Power quality disturbances and its impact on economy is not limited only to the United States. As another example, the economic impact of voltage sags for a subset of industries operating in China revealed an estimate of the total cost incurred by the chemical fiber industry as ranging from $29,000 to $172,000 per voltage sag, while the semiconductor industry faced significantly higher amounts, of values between $574,000 and $3,585,000 per (voltage sag) event.

A voltage sag of 80% (of nominal value) for only a few cycles, can disrupt the production process in the semiconductor industry and may cause a loss of $0.5-$2 million per interruption event. For instance, as reported by Reuters, in March 2018, a 30-minute power interruption at a Samsung chip plant in Pyeongtaek, South Korea, damaged an estimated 50,000 to 60,000 wafers of V-NAND flash memory—an estimated loss of $43 million.

Equipment used in the production facilities of the semiconductor industry is very expensive and requires precisely controlled operating conditions. This requires electric power input into every device to be maintained at high standards. Therefore, it is desirable that any disturbance in the power quality supplied to each device should be mitigated or detected and escalated to operator review at the earliest possible time.

Common sources of harmonics distortion, a class of PQI in which waveforms of integer multiples of the primary frequency can form and distort the primary frequency, e.g. 60 Hz in the USA, in these facilities are largely because of “nonlinear loads,” including variable frequency drives (VFD), switched mode power suppliers (SMPS), uninterrupted power supplies (UPS), high-power rectifiers, electroplating and chemical processing and ion implantation equipment. These types of equipment can generate substantial harmonic currents, which manifest as harmonic voltages due to line impedance. Further, electrical arcing devices such as plasma etchers, can also generate a wide spectrum of harmonics due to the highly non-linear nature of the arc. For example, as the semiconductor industry moves toward smaller feature sizes required for its chips, it is important to monitor and filter impacts of plasma etchers on the material processes available in fabs.

Power electronic converters are another area of concern and pose a problem that is becoming more pronounced as renewable energy is integrated into existing power networks. The variability in weather patterns due to climate change can impact energy generation by solar panels or wind turbines. These impacts can often cause frequency variations in an otherwise distributed power network.

Future power networks will be distributed and will rely more and more on renewable energy, such as wind and solar energy. On the consumer side, more electric vehicles (EVs) and consumer electronics may cause more frequent and complex PQ issues. One complexity is that harmonic distortions rea occurring at higher-frequencies, in particular the “supraharmonics” spectrum from 2 kHz-150 KHz. “Superharmonics” are often caused by embedded inverter technology, active rectifier loads, for example, in electric vehicle (EV) charging stations, personal computers (PCs), consumer electronics, light emitting diodes (LEDs), and modern lighting systems. Power supply relying on distributed renewable energy sources (e.g. wind energy) are also known to cause the emission of “supraharmonics.” Therefore, with increasing global adoption of renewable energy, “supraharmonics” is considered to be the most pressing power quality concern of the future The challenge in addressing this new family of power quality issues is that typical power quality analyzers do not sample fast enough to measure the full suprharmonic spectrum.

Real-time sensing of monitored systems is not a trivial task, especially at the higher sampling rate frequencies where there are compounding changes with hardware cost and requirements, scalability, data storage, inference latency, and integration with current business system

There is a dire need for solutions to better monitor and detect power quality issues, given the high operational cost of these issues and the increasing prevalence of disturbances at higher frequencies.

### SUMMARY OF THE INVENTION

The present invention overcomes the deficiencies and limitations of the prior art at least in part by providing an intelligent, AI-enabled, detection system and methods configured to detect and characterize power quality issues (“PQIs”), by using independently artificial intelligence and machine learning models on each power quality issue and sequentially deploying them. The system is structured in a multi-tier architecture with PQI agents that are deployed reliably to monitor power quality issues in reduced time and with the capability for the models to dynamically update on new data to adjust to the constantly changing conditions of the power grid. The PQI agents in the context of this disclosure are software systems designed and trained to operate autonomously, make decisions, learn, and adapt to new data, information, and specific defined goals. When deployed, the PQI agents operate in the real-world or simulated environments, making decisions and taking actions based on their training.

In some implementations, the system in accordance with the present invention utilizes a “plug-and-play” and extensible PQI-aware AI detection system, which uses Normalizing Flows (NF) and leverages a data-driven and customizable anomaly score to guide engineers through their Root-Cause-Analysis (“RCA”) of power quality (PQ) events. The anomaly score is based on negative log-likelihood.

The intelligent system design is PQI-agnostic, allows for seamless integration with various power quality (PQ) monitoring systems, adjusted to different sensitivity or threshold levels to identify different classes of power quality issues (PQIs). Additionally, the intelligent system and methods use a multi-tiered approach to training the AI-models that enable efficient deployment of the PQI Agents, and continuous improvement of each specific PQI Agent as needed, which significantly reduces the time-to-deployment and online-monitoring tasks. The multi-tiered approach also solves the “cold-start” problem where high-quality labeled data for every class of power quality (PQ) issues must be present in the training dataset to train a classification and detection system using traditional ML and AI approaches.

In some implementations, the intelligent system uses empirical Cumulative Distribution Function (CDF) calculation and the Bayesian Quadratic Discriminant Analysis (QDA) with the cost matrix.

In some implementations, the intelligent system includes a robust and configurable alarm-rate decision matrix, which introduces input by expert systems, human experts, engineers, or operators, to calibrate the trade-off between alert fatigue and accuracy requirements of power quality issue (PQI) detection agents demanded by business priorities.

In some implementations in one example scenario that addresses the growing concern with “supraharmonics,” the advances of the present invention use a hybrid approach consisting of inferring the state of the system along with high sampling rates, to track and identify characteristics signatures emitted by “supraharmonics.” High-frequency power data can benefit PQI detection and classification for many classes of PQIs beyond “supraharmonics.” The AI models used in the present system optimally leverage continuous (waveform) high-frequency power data. The previously cost-prohibitive nature of obtaining continuous (waveform) high-frequency data (i.e., sufficient samples to resolve waveforms in the general case and roughly >8 kHz and optimally ˜150 kHz for supra-harmonics) resulted in any application of AI applied to power quality issues (PQIs) being based on low-frequency data and/or aggregated calculations based on periodic snapshots of high-frequency data (e.g., harmonics calculations based on the IEEE (Institute of Electrical and Electronics Engineers) 519 standard, with measurement methods based on the IEC (International Electrotechnical Commission) 61000-4-7 standard.

In some implementations the system recognizes that there is a need for all different classes of PQ events or issues, and instead of just measuring the current state of the power system supplied and given the standards (that are always known a priori), returns a set of errors and labels all as ‘anomalous’ behavior, with respect to the standard/normal behavior. The Intelligent AI-enabled system returns a generic and PQI-agnostic anomaly score for data vectors collected over a given window of time. For the purpose of this disclosure, a PQI-agnostic anomaly score is a probabilistic score that can be truncated to indicated ‘normal’ (and expected) conditions vs strong abnormal behavior; with large deviations of newly collected/sampled data from what PQ ‘expected & normal behavior models have been trained on. Modern power quality monitoring is expected to provide the necessary means for tasks required by business and engineering teams, for example, performing root-cause-analysis on recorded events; facilitating power quality issue mitigation; being flexible to varying demands; reconfiguration of plants etc.; helping different engineering and operation teams create “control-tower-view” into their facilities and its resilience against power quality issues; enabling backed-by-data recommendations on predictive maintenance of different machines, devices or even PQI mitigation setups in their facilities. It should be recognized that a “control-tower-view” in the context of this disclosure refers to a top down, multi-layered and wide dynamic view into the operation and monitoring metrics computed from various sensors in any plants or facility.

With the increase in energy generation by renewable sources such as wind and power, electric inverters are increasingly needed to deliver stable frequency and high-quality power. This expansion causes a new challenge, by a reduction of the power network's inertia, whereby changes in load result in a higher rate of change of grid frequency. The intelligent system in accordance with the present invention uses accurate and non-linear controllers, e.g., model predictive control, to provide predictive maintenance and device health scores, to address the mounting issues that remain unaddressed by existing power quality monitors installed and in operation.

### BRIEF DESCRIPTION OF THE DRAWINGS

The present invention is illustrated by way of example, and not by way of limitation in the figures of the accompanying drawings in which like reference numerals are used to refer to the same or similar elements.

FIG. 1 is high-level block diagram illustrating an environment in which the Intelligent AI-enabled system configured to detect and characterizes power quality issues operates according to some implementations of the present invention disclosed herein.

FIG. 2 is a high-level block diagram illustrating the software and hardware elements of the Intelligent AI-enabled system including the multi-tier power quality issue (PQI) agents according to some implementations disclosed herein.

FIG. 3 is a high-level block diagram of the hardware and software components including artificial intelligence and machine learning models of the Intelligent AI-enabled system according to some implementations disclosed herein.

FIG. 4 is a high-level block diagram of an example power network according to some implementations disclosed herein.

FIG. 5 is a high-level block diagram of an example architecture (with neural network subcomponents) and method illustrating the steps for training an AI system utilizing Normalizing Flow according to some implementations disclosed herein.

FIG. 6A is a high-level block diagram of an example system architecture for the models to dynamically update on new data to adjust to the constantly changing conditions of the grid according to some implementations disclosed herein.

FIG. 6B is a representation of the AI model tracking the changing condition in data and its prior knowledge of any PQI.

FIG. 7 is a table illustrating the voltage test requirements based on SEMI F47 standard (the points representing the voltage are shown in FIG. 8).

FIG. 8 illustrates the SEMI F47-0706 standard (most recent version) that is required (+) and recommended (X) duration for different values of voltage sag. Adoption of this standard by the semiconductor manufacturing plants have saved hundreds of millions of $ (USD) by mitigating interruptions due to voltage sags in their fabs.

FIG. 9 illustrates schematics and reference architecture of the Intelligent AI-enabled system according to some implementations disclosed herein.

FIG. 10 illustrates an example skeleton of the implementation of a generic programming software class labeled as “PQIssue Agent.” This generic class enables addition of any new PQIs as human subject matter expert (“SME”) intends to augment their PQI model repository.

FIG. 11 illustrates an example data schema to instantiate a single PQI agent class (example shown in FIG. 10) according to some implementations disclosed herein.

FIG. 12 illustrates example process steps to build a knowledge base containing PQI behavior in waveform data according to some implementations described herein. From the top to the bottom, waveform data used to train the AI models becomes richer and customized to the site (e.g. a fab) or devices being monitored by the Intelligent AI-enabled system.

FIG. 13 illustrates an example user interface facilitating queries and prompts with different levels of complexity that may be asked of the Intelligent AI-enabled system, and how the system may express and transform these queries into conditional probability calculations that can be computed from the trained models (i.e. high dimensional complex probability distributions).

FIG. 14 illustrates a block diagram illustrating the behavior of the anomaly scoring function S, as defined by the illustrated algorithm described below in the description of FIG. 14 when it is applied to voltage data, according to some implementations disclosed herein.

FIG. 15 illustrates a block diagram of the overall architecture of the PQI detection system performing inference on real-time data according to some implementations disclosed herein.

FIG. 16 illustrates an example graphical representation of the characterization and root cause analysis results generated by the Intelligent AI-enabled system in accordance with some implementations disclosed herein. For a given event (with a high anomaly score), a user may pick an explainer AI (XAI) engine to find out the most relevant features and subsequently the PQI class causing the anomaly score to surpass the alert threshold (red line).

FIG. 17 illustrates example schematics of the ‘Feature Engineering’ module of the Intelligent AI-enabled system according to some implementations disclosed herein. Raw waveform (PQ) data is streamed, scaled, or transformed according to various levels of computational complexity and information richness. The final aggregated feature vector X is returned and may be used by anomaly score and PQI Agents for inference.

FIG. 18 illustrates an example of a basic confusion matrix for a binary classification to detect a given PQI in accordance with some implementations disclosed herein.

FIG. 19 illustrates example schematics of the factors required to build the misclassification cost matrix in the Intelligent AI-enabled system disclosed herein. In the Intelligent AI-enabled system illustrated, a business-aware and flexible approach is allowed to apply the trade-off amongst financial loss (as a result of equipment interruption), the risk of damage to fab equipment, existing service level agreements (SLA) and quality control requirements, and the PQI detection mode via C (g, h) matrix.

FIG. 20 illustrates an example misclassification matrix in accordance with some implementations disclosed herein. For the sake of notation consistency, in the formulation described, it should be assumed that PQI₀ denotes ‘normal behavior’ expected of the power system being monitored.

FIG. 21 illustrates fine-tuning the classification decision boundary according to business and prediction accuracy requirements in accordance with some implementations disclosed herein. Consider a trained (AI) model in the middle without any human infusing her priorities in the model predictions. Left: Higher Precision for PQI class voltage sag. Right: Higher Recall for PQI class voltage sag. User can calibrate the values in the misclassification matrix C(g,h) (also shown in FIG. 20) according to her optimal point needed to balance the AI model accuracy requirements, alert-fatigue, AI model sensitivity, or any hard/soft constraints required by business and safety requirements.

FIG. 22 illustrates the schematics of the transformations process used in Normalizing Flows in accordance with some implementations disclosed herein. Every transformation function fj is invertible and differentiable.

FIG. 23 is a flow chart illustrating the process of dynamically updating the models on new data to adjust to the constantly changing conditions of the grid in accordance with some implementations disclosed herein.

FIG. 24 is a flow chart illustrating the process for detecting power quality issues (PQIs).

FIG. 25 is a flow chart illustrating the process of training the ML models for detecting power quality issues.

FIG. 26 is a flow chart illustrating the process for using different statistical metrics as features for monitoring PQIs.

FIG. 27 is a flow chart illustrating the continuing process illustrated in FIG. 26 via connector “A.”

### DETAILED DESCRIPTION OF THE EMBODIMENTS

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or described more generally in order to avoid obscuring the invention. It should be noted that there are many different and alternative configurations, devices, and technologies to which the disclosed inventions may be applied. The full scope of the inventions is not limited to any examples or embodiments that are described below nor should any examples or embodiments be construed in any way as limiting the applications of the invention. For example, the present invention is described in some implementations below with reference to user interfaces and particular hardware.

Reference in the specification to “one embodiment or implementation” or “an embodiment or implementation” means that a particular feature, structure, or characteristic described in connection with the embodiment or implementation is included in at least one embodiment or implementation of the invention. The appearances of the phrase “in one embodiment” or “in one implementation” in various places in the specification are not necessarily all referring to the same embodiment or implementation.

Some portions of the detailed descriptions that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This system architecture may be specially constructed for the required purposes, or it may comprise computers selectively activated or reconfigured by a computer program stored in the computers. Such a computer program may be stored in a computer readable storage medium, such as, but is not limited to, any type of disk including floppy disks, optical disks, CD-ROMs, and magnetic disks, read-only memories (ROMs), random access memories (RAMs), EPROMs, EEPROMs, magnetic or optical cards, flash memories including USB keys with non-volatile memory, cloud-based systems, or any type of media suitable for storing electronic instructions, each coupled to a computer system bus.

Parts of the invention can take the form of an entirely hardware embodiment, an entirely software embodiment or an embodiment containing both hardware and software elements. In some illustrated embodiments, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, cloud-based memory systems, and cache memories which provide temporary storage of at least some program code to reduce the number of times code must be retrieved from bulk storage during execution.

Input/output or I/O devices (including but not limited to keyboards, displays, pointing devices, etc.) can be coupled to the system disclosed either directly or through intervening I/O controllers. Network adapters may also be coupled to the disclosed system to enable the data processing system to become coupled to other data processing systems or remote printers or storage devices through intervening private or public networks. Modems, wireless modems, cable modem and Ethernet cards are just a few of the currently available types of network adapters.

Finally, the algorithms and displays presented herein are not inherently related to any particular computer or other apparatus. Various general-purpose systems may be used with and controlled by special programs in accordance with the teachings herein, or it may prove convenient to construct more specialized apparatuses to perform the required method steps. The required structure for a variety of these systems will appear from the description below. In addition, the present invention is not described with reference to any particular programming language. It will be appreciated that a variety of programming languages may be used to implement the teachings of the invention as described herein.

Further, the process parameters and sequence of steps described and/or illustrated herein are provided by way of example only and can be varied as desired. For example, while the steps illustrated and/or described herein may be shown or discussed in a particular order, these steps do not necessarily need to be performed in the order illustrated or described. The various exemplary methods described and/or illustrated herein may also omit one or more of the steps described or illustrated herein or include additional steps in addition to those disclosed.

For the purpose of clarity, orientation and differentiation, certain key terms used throughout this application are described. For example, “artificial intelligence” refers to the capacity of computers or other machines to exhibit or simulate intelligent behavior through optimal experimental design (“OED”), which is abbreviated throughout this description as “AI.” Artificial intelligence is also described as allowing computers to learn from experience and understand the world in terms of a hierarchy of concepts, each defined through its relation to simpler concepts. The hierarchy of these concepts enables the computer to learn complicated concepts from building them out of simpler ones. Within this description, artificial intelligence covers multiple sub-domains, including machine learning, and deep learning. The term “machine learning” refers to a subset of artificial intelligence, called machine learning (“ML”), which is generally defined as a system that can extract patterns from raw data, allowing the system to gain the ability to acquire knowledge specific to the raw input data. At its core, machine learning involves limited representational learning, by using subsets of raw data that distinguish ideal descriptions or conditions of interest. These subsets of ideal conditions are also denoted as features herein. It should be recognized that in general, the success of a machine learning approach depends on correlating whether the features identified within the raw data by a processing algorithm actually are correlated to the desired outcome of the data analysis problem itself.

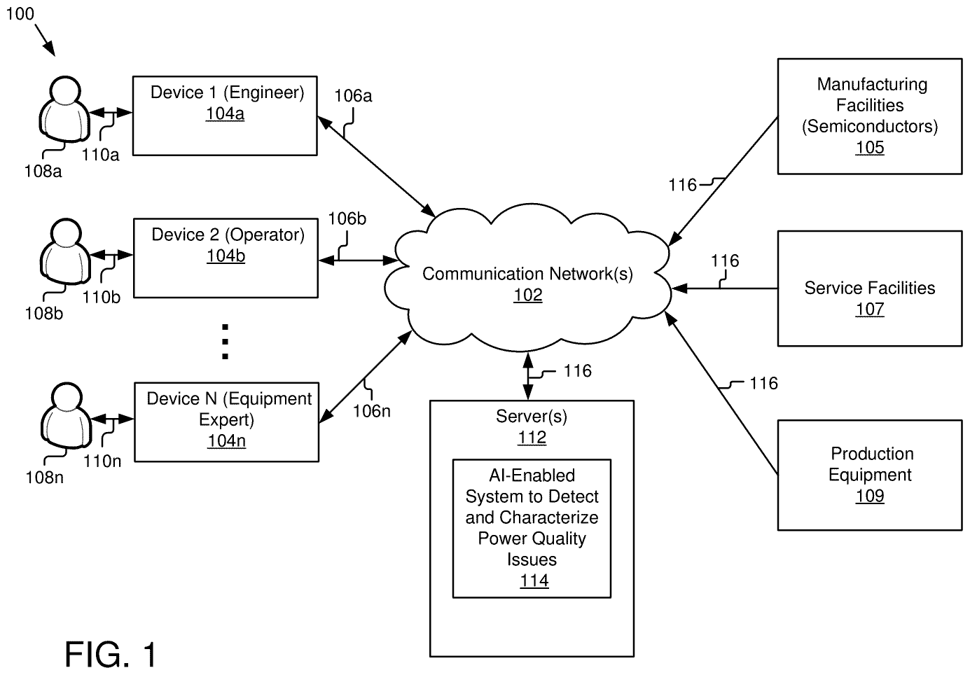

Referring now to FIG. 1, the specification describes an Intelligent AI-enabled system to detect and characterize power quality issues (“PQI’) system as designated by reference numeral 114 and illustrated in a distributed environment designated generally by reference numeral 100. The distributed environment 110 includes servers 112, devices 104, and facilities 105 and 107 and production equipment 109 coupled via one or more networks 102. The Intelligent AI-enabled system to detect and characterize power quality issues is also referred to as the “Intelligent AI-enabled system 114” throughout this disclosure.

The Intelligent AI-enabled system 114 utilizes artificial intelligence (AI) and machine learning models (ML) for detecting and analyzing power quality issues (“PQI”). The intelligent AL-enabled system 114 serves as an extensible PQI-aware AI detection system, which serves as a “plug-and-play” system that can integrate with any application, environment, or facility. The Intelligent AI-enabled system 114 independently trains artificial intelligence (“AI”) and machine learning (“ML”) models on each power quality issue and sequentially deploys them. The Intelligent AI-enabled system 114 is structured in a multi-tier architecture with PQI agents that are deployed reliably to monitor power quality issues in reduced time and with the capability for the models to dynamically update on new data to adjust to the constantly changing conditions of the power grid. The Intelligent AI-enabled system 114 applies and uses normalizing flow (“NF”) models for learning the probability distributions of normal and anomalous states, computing or generating anomaly scores based on a negative log-likelihood mathematical function, performing empirical Cumulative Distribution Function (“CDF”) calculation, and the Bayesian Quadratic Discriminant Analysis (“QDA”) with the cost matrix.

The Intelligent AI-enabled system 114 as illustrated is coupled to user devices 104a, 104b, through 104n, for example, for use by an engineer 108a, an operator 108b, an equipment expert 108n, or others. Each communicates via their respective devices, via input signals 110a, 110b, through 110n, to transmit control and data signals (as illustrated by signals 106a, 106b, through 106n) via the communication network(s) 102 to the servers of the Intelligent AI-enabled system 114. The Intelligent AI-enabled system 114 communicates with the communication network(s) 102 via signal line 116. The other facilities are also illustrated as communicating with the communication network(s) 102 via signal line 116.

The Intelligent AL-enabled system 114 provides a data-driven and customizable anomaly score to guide engineers, operators, and others to conduct root cause analysis of power quality issues, also referred to herein as “Root-Cause-Analysis” (hereinafter, otherwise referred to as “RCA”) of the power quality events. The Intelligent AI-enabled system 114 is configured to be PQI-agnostic, enabling seamless integration with various power quality monitoring systems of different sensitivity or thresholds that are used to identify different classes of power quality issues in any facility. The intelligent-AI enabled system 114 is illustrated as coupled via a communication network(s) 102 to diverse facilities, for example, from any industry sector, such as a semiconductor fabrication facility (fab) or other.

The communication network(s) 102 may be of conventional type, wired or wireless, and may have any number of configurations such as a star configuration, token ring configuration or other configurations known to those skilled in the art. Furthermore, the communication network(s) 102 may comprise a local area network (LAN), a wide area network (WAN) (e.g., the Internet), and/or any other interconnected data path across which multiple devices may communicate. In yet another implementation the communication network(s) 102 may be a peer-to-peer network. The communication network(s) 102 may also be coupled to or includes portions of a telecommunications network for sending data in a variety of different communication protocols. In yet another implementation the communication network(s) 102 may include Bluetooth communication network or a cellular communications network for sending and receiving data such as via short messaging service (SMS), multimedia messaging service (MMS), hypertext transfer protocol (HTTP), direct data connection, WAP, email, etc. The communication network(s) 102 as illustrated facilitates cloud connectivity via cloud infrastructure, which includes the hardware and software components, such as servers, storage, networking, virtualization software, services and management tools, that support the computing requirements of a cloud computing model. The cloud infrastructure also includes an abstraction layer that virtualizes and logically presents resources and services to users through application programming interfaces (“APIs”) and API-enabled command-line or graphical interfaces if required.

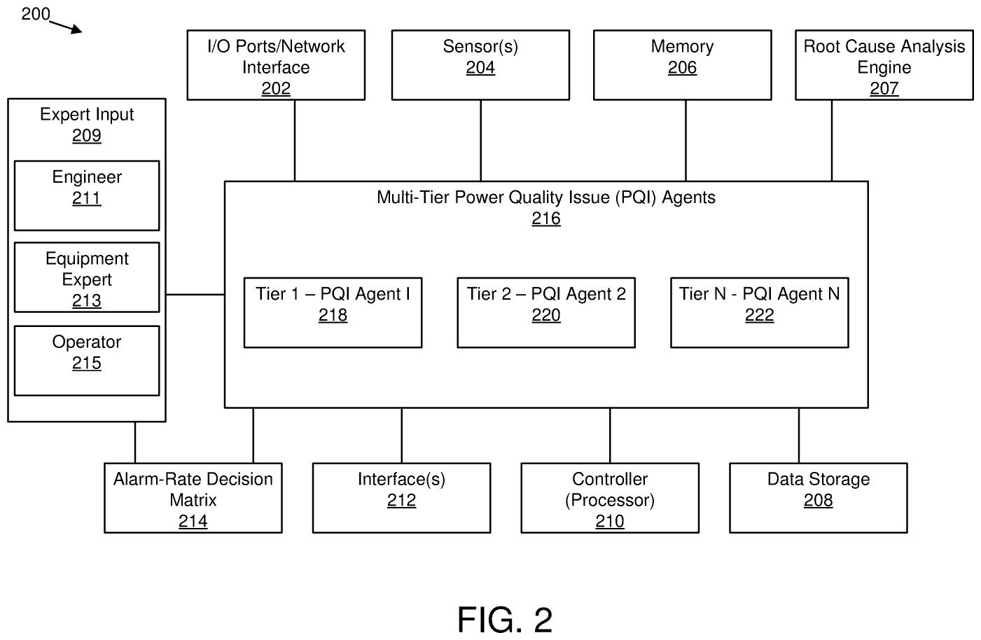

Referring now to FIG. 2, the multi-tier architecture of the Intelligent AI-enabled system 114 and its ML models is illustrated generally and designated by reference numeral 200. The multi-tier architecture and framework is ideal for training of the ML models described here. It enables efficient improvement and deployment of multiple “PQI Agents,” collectively referenced as multi-tier power quality issue agents 216 that are configured for and dedicated to different power quality issues. As illustrated, a PQI Agent 1 within a designated Tier 1 layer designated by reference numeral 218 processes a distinct power quality issue from PQI Agent 2 within a designated Tier 2 layer, designated by reference numeral 220. It should be recognized that any number of PQI agents may be utilized, as designated by PQI Agent N within Tier N designated by reference numeral 222. Each PQI Agent may be trained and updated (with feedback or monitoring data that is continuously provided) separate and apart from the other PQI Agents. This reduces critical time to deployment and reduces complexities associated with building one master model that can detect all PQIs. Online monitoring of power systems in diverse facilities that may be distributed in local, regional, or global areas are more reliably determined.

The training and use of these PQI Agents facilitate detecting data that is used to guide engineers and others in their root cause analyses that may be performed via the root cause analysis engine 207. To perform root cause analysis on any given power network, it is critical to first define the parameters of interest, which are measured or estimated. As is recognized by those skilled in this field, in general, the quality of electrical power supplies is characterized by a set of internationally predefined parameters, for example, voltage, frequency, phase angles, and waveform properties. This allows any power supply system to be rated according to clearly stated tests provided in common international standards, for example, IEC, IEEE, EI (Electrical Installation), ANSI (American National Standards Institute), NIST (National Institute of Standards and Technology), etc., also referenced above. These standards aim to define and characterize ‘deviations’ of measured (actual) parameters from nominal values. In doing so, usually the severity, duration of deviation, or waveform distortions observed in an otherwise normal power grid, are employed to define various categories of deviations, power quality (PQ) disturbance, power quality (PQ) anomalies, power quality (PQ) interruption, power quality (PQ) event, power quality (PQ) issue, are only a few example terminologies.

It should be recognized that engineering textbooks and power quality (PQ) standards may differentiate between terms such as “power quality issue” or “power quality disturbance” or “power quality deviations.” In the Intelligent AI-enabled system 114 disclosed herein, the term “Power Quality Issue” (PQI) represents a set or subset of power quality concerns sought by operating engineers. By considering factors such as the duration of PQI, e.g., a few cycles (tens of milliseconds) versus thousands of cycles (seconds), the nature of the PQI triggering mechanism, for example, power quality (PQ) interruptions versus high-frequency harmonics or transients, and sustained and stable deviations, for example, voltage sag of 1% versus voltage sag of 15%, several families of PQIs are identifiable. It should also be recognized that providing precise definitions for every PQI is not possible for the purpose of this disclosure, therefore, this disclosure encompasses all surveys and references known to those skilled in the art that offer definitions for PQIs commonly defined by internationally recognized engineering associations, e.g. IEEE [also referenced above).

The multi-tier architecture also includes I/O ports 202, sensor(s) 204 located in the power supply or other facilities (under surveillance for monitoring of power issues), data processing system (with processor and memory) 206, one or more expert input channels 209 (for expert systems) that may provide expert input in training or the root cause analysis. The expert input 209 may be an engineer 211, an equipment expert 213, or an operator 215, or any other person or machine that can provide data or insights in preventing disruption to power networks.

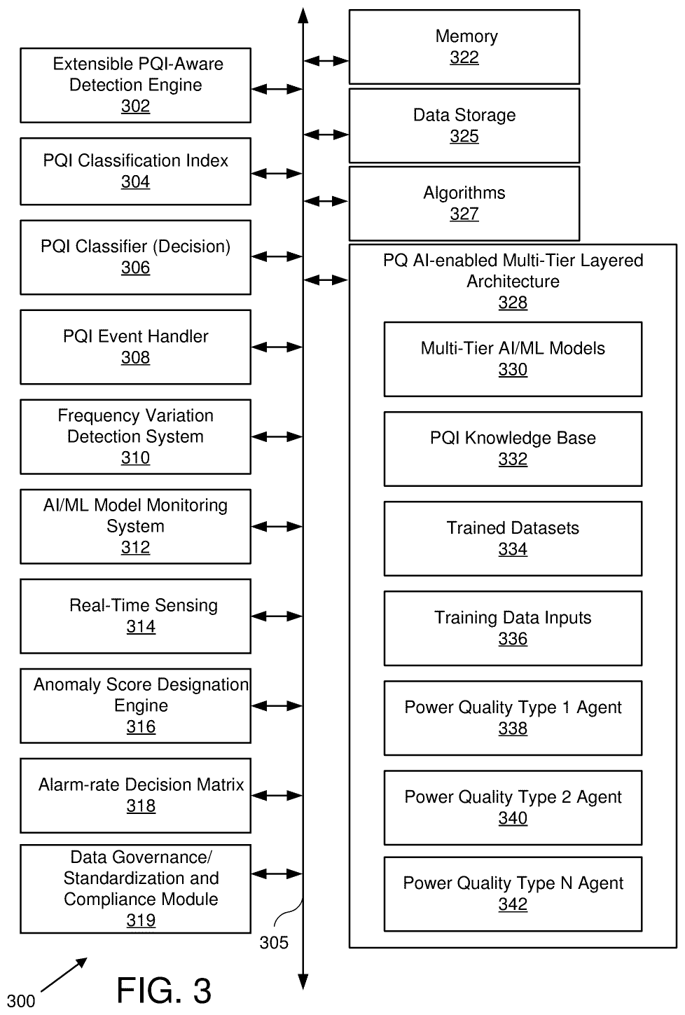

The memory 206 is suitable for storing and/or executing program code by at least one controller/processor 210 coupled directly or indirectly to memory elements of the memory 206 through a system bus (see FIG. 3, 305). The memory 206 may include local memory employed during actual execution of the program code, bulk storage, cloud-based memory systems, and cache memories which provide temporary storage of at least some program code to reduce the number of times, code must be retrieved from bulk storage during execution.

In some implementations, the memory 206 may store instructions and/or data that may be executed by the controller/processor 210. The memory 206 is coupled for communication with the other components illustrated. The instructions and/or data may comprise code for performing any and/or all of the techniques disclosed herein. The memory 206 may be a dynamic random-access memory (DRAM) device, a static random-access memory (SRAM) device, flash memory or some other memory device known in the art.

In some implementations, a data storage 208 stores data, information and instructions used by the Intelligent AI-enabled system 114 and its various components, modules, and engines disclosed herein. The data storage 208 may be a non-volatile memory or similar permanent storage device and media such as a hard disk drive, a floppy disk drive, a CD-ROM device, a DVD-ROM device, a DVD-RAM device, a DVD-RW device, a flash memory device, or some other mass storage device known in the art for storing information on a more permanent basis. Cloud storage may be computer data storage in which the digital data is stored in logical pools, said to be on “the cloud.” The physical storage spans multiple servers (sometimes in multiple locations), and the physical environment may be owned and managed by a hosting company.

The data storage 208 is coupled by the bus for communication with other components of the system. The input-output (“I/O”) ports or network interface 202 connect to other components for transmission and display of select data as desired. The network interface 202 is coupled to the communication network(s) 102 (see FIG. 1). The network interface 202 includes the I/O ports for wired connectivity such as but not limited to USB, SD, or CAT-5, etc. The network interface 202 links the controller or processor 210 to the communication network(s) 102 that may in turn be coupled to other processing systems. The communication network(s) 102 may comprise a local area network (LAN), a wide area network (WAN) (e.g., the Internet), and/or any other interconnected data path across which multiple devices may communicate. The network interface 202 provides other conventional connections to the networked desktop workstation 106 using standard network protocols such as TCP/IP, HTTP, HTTPS and SMTP as will be recognized and understood by those skilled in the art. In other embodiments, the network-interface module 202 includes a transceiver for sending and receiving signals using WIFI, Bluetooth® or cellular communications for wireless communication.

The controller or processor 210 may comprise an arithmetic logic unit, a microprocessor, a general-purpose controller or some other processor array configured to perform programmed computations and provide electronic display signals to a display. The computer or processor 210 is coupled to the bus for communication with the other components. The controller or processor 210 processes data signals and may comprise various computing architectures including a complex instruction set computer (CISC) architecture, a reduced instruction set computer (RISC) architecture, or an architecture implementing a combination of instruction sets. Although only a single controller or processor is shown in FIG. 2, multiple controllers or processors are used. It will be obvious to one skilled in the art that other processors, operating systems, sensors, displays and physical configurations are possible.

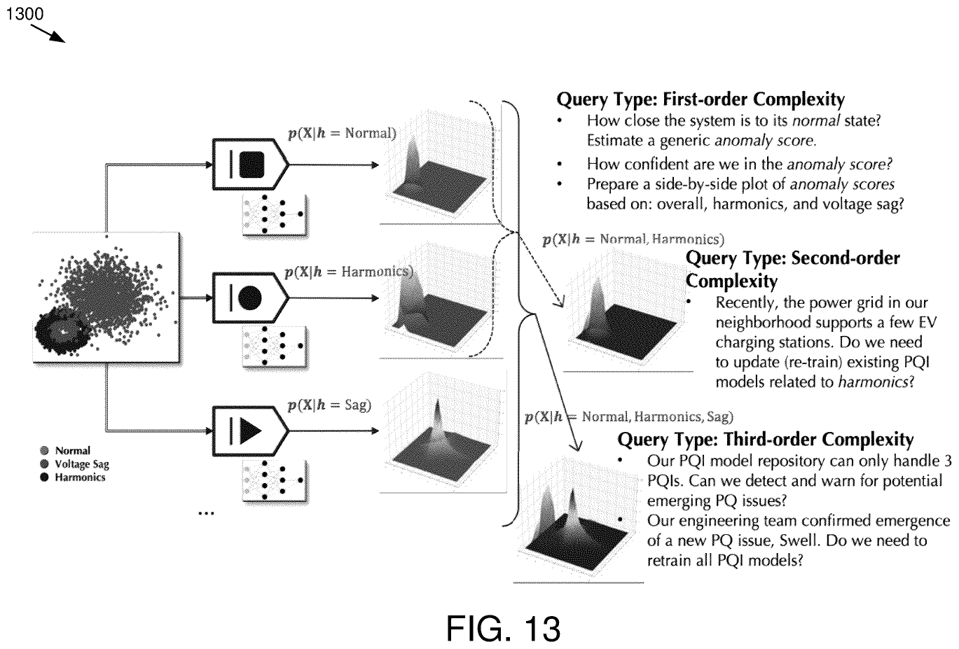

In some implementations, the architecture disclosed herein also incorporates a robust and configurable alarm-rate decision matrix 214, which serves to introduce the expert systems including human experts, engineers, and/or operators to calibrate the trade-off between alert fatigue and requirements of accuracy demanded by business priorities. In some implementations, the alarm-rate decision matrix 214 serves to provide access and one or more capabilities or tools for expert input illustrated by block 209, for example, if an engineer 211 determines an alarming situation to warn for emerging power quality issues on the horizon or whether or not any specific power quality issue (PQI) model requires re-training (see FIG. 13).

The categories of human domain experts that are required to train the AI/ML models or trouble shoot power quality issues include power quality experts, who are versed in troubleshooting and analyzing electrical data etc., and equipment experts 213, who are typically engineers 211 at the customers' industrial facilities or at the original equipment manufacturer's site (OEM) who are responsible for equipment uptime, maintenance/reliability, troubleshooting, repair, and other types of technical support for installed-base equipment.

Further, to provide context for some of the terms used herein, explanations are set forth here. The term “power quality,” as referenced herein, describes how well an electric power grid operates within its normal (design) parameters. The power quality measures the stability, consistency, and reliability of the electric power. When the grid is not expected to operate under its nominal (design) parameters, power quality issues are revealed. For instance, nominal frequency of the electric grid in the USA is f₀ 60 Hz. Factors such as load, device type, weather-related interruptions, etc., can substantially impact the electricity network. Therefore, the actual operating frequency is accepted to fluctuate within a manageable range, e.g. 0.5 Hz of the nominal value (60 Hz). Generally speaking, power network apparatus as well as the majority of consumer electronic devices are designed to be resilient against deviations from nominal values of frequency, voltage, etc. However, more pronounced deviations or events, along with high-technology nature of industries such as semiconductor manufacturing, can have secondary impact, e.g. shutting down a plant temporarily to mitigate a voltage sag.

While the inventions described herein may be used in various applications (e.g., semiconductor manufacturing, medical imaging, etc.), some of the implementations described herein are with a focus on PQIs impacting the semiconductor manufacturing industry, which is described only by way of example. The remarkably high standards required by the manufacturing process demand stringent operating conditions which, in turn, rely on superior power quality to be provided to hundreds or thousands of machines in the fab. Furthermore, every machine should tolerate PQ deviations up to a certain threshold according to accepted standards, e.g., IMF used in the end-to-end production facilities commonly known as fab. The most common PQIs impacting semiconductor industry include voltage sag, interruptions, harmonics, and voltage swell.

In the Intelligent AI-enabled system 114 disclosed here, any number of valuable contextual data streams may be used, for example, those that provide a direct insight into the operational state and physical condition of the equipment and its immediate environment. This data is valuable in bridging the gap between an electrical anomaly and the root cause of the anomaly. These data streams offer significant and immediate potential for improving model accuracy and enabling robust Root Cause Analysis (RCA). They are tightly coupled with the electrical behavior of sophisticated equipment.

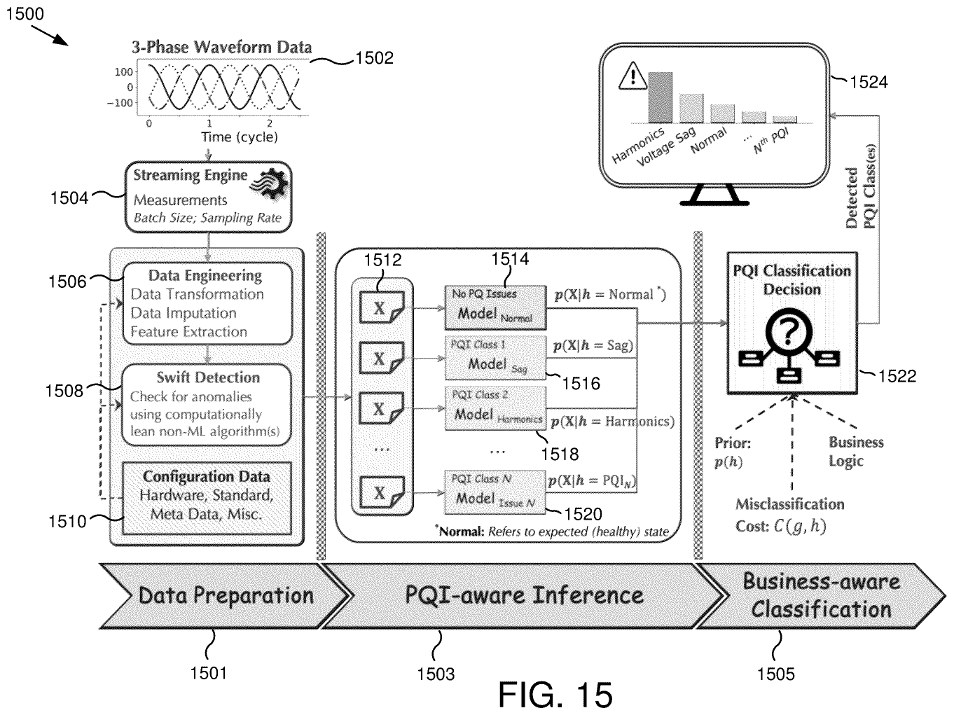

Referring now to FIG. 3, the various hardware and software components of the Intelligent AI-enabled system 114 are illustrated and described. These include an extensible PQI-aware detection engine 302, a PQI classification index 304, a PQI classifier (Classification Decision) 306, a PQI event handler 308, a frequency variation detection system 310, an AI/ML model monitoring system 312, real-time sensing components and module 314, an anomaly score designation engine 316 (to compute or generate anomaly scores based on a negative log-likelihood mathematical function, described in greater detail below), an alarm-rate decision matrix 318, data governance and standardization and compliance module 319, memory 322, data storage 325, and algorithms 327. Each of these components comprise software that is executable code configured to operate the functions disclosed and described here. The extensible PQI-aware detection engine 302 is configured to continuously monitor power supply facilities, industrial complexes, manufacturing facilities or industrial and power equipment to identify power quality issues to avoid disruptions or if disrupted to quickly address them. In some implementations, the extensible PQI-aware detection engine 302 integrates with normalizing flow models, which enable advanced probabilistic modeling of power quality metrics, anomaly detection, or forecasting power quality events. The extensible PQI-aware detection engine 302 comprises data preparation modules, PQI-aware inference modules and business-aware classifications described in greater detail below with reference to FIG. 15. The business-aware classifications step by use of the Bayesian QDA framework and the configurable misclassification cost matrix C(g,h) are described with reference to FIGS. 15, 19, 20, and 21 and algorithm 22 later in this disclosure.

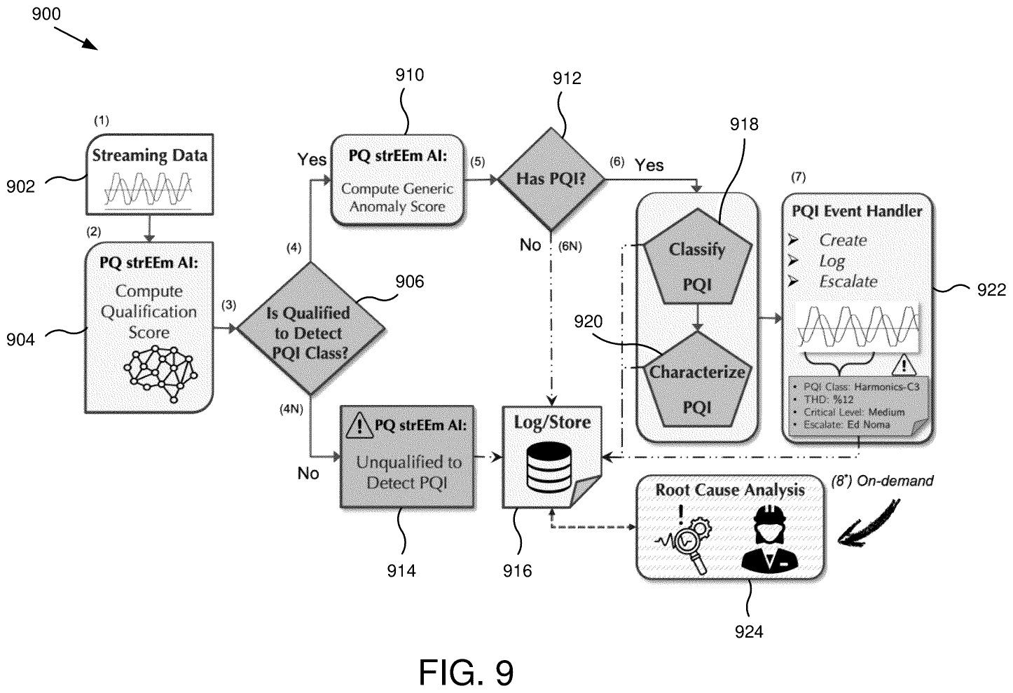

The PQI classification index 304 identifies the various classes of power quality issues. The PQI classification index 304 includes proper indexing of classes and any misclassifications, which is described in greater detail below. The PQI classifier (Classification Decision) 306 is tasked with maintaining the different PQI classes and informing if a particular AI/ML model is qualified or unqualified to detect a power quality issue. It utilizes prior knowledge on the occurrence frequency of different classes of PQIs via the probability distribution including all classes, as described in greater detail below. The PQI event handler 308 (also 922 in FIG. 9) tracks each power quality issue as it occurs. The PQI event handler 322 creates a log of each event and escalates an issue of concern. The frequency variation detection system 310 tracks the frequency variations as they occur. The AI model monitoring system 312 tracks the AL/ML models to ensure they are performing and trigger a signal when any particular model has to be updated or modified. In some implementations, by integrating the AI's output directing into the equipment's control system, a passive alert may be transformed into an active tool for optimization. In some implementations, the AI's output may be used to make minor real-time adjustments to critical process parameters. For example, if the AI detects rising harmonic distortion that could affect plasma stability in an etch tool, the controller could slightly alter the RF power, gas mixture, or chamber pressure to maintain process integrity.

The real-time sensing components and module 314 includes software instructions coupled to physical sensor components located in the facilities (or equipment) being monitored. Signals from the physical sensor components are transmitted in accordance with techniques known in the art.

The anomaly score designation engine 316 assigns scores to power quality issues as they occur and are identified. The alarm-rate decision matrix 318 (214 in FIG. 2) is described above. The data governance and standardization and compliance module 319 maintains all the files and rules on the compliance standards. The data governance module 319 includes storage that is continuously updated with relevant meta-data, security and privacy, on-edge or cloud-based storage (a few examples). The standardization and compliance module 319 includes standards as well as compliance requirements, which evolve over time. Many power quality tasks require careful calibration and configurations performed by engineers. This module 319 adapts to new requirements, which is typically non-trivial and costly.

In the context of this disclosure, it should be recognized that the term “frequency variations” refers to changes in the frequency of a signal, wave, or alternating current over time, deviating from a reference or nominal frequency. The term “low-inertia power grids,” refers to a result of decoupling of actual load (demand) and available power (supply) in the network.

The algorithms 327 executes all the functions required to implement the various processes described in greater detail below (e.g., all the algorithms described herein). The Intelligent AI-enabled system 114 further comprises a PQ AI-enabled multi-tier layered architecture 328, which includes multi-tier AI/ML models 330 (e.g., the NF models), a PQI knowledge base 332, trained datasets 334, training data inputs 336, a plurality of power quality agents including power quality type 1 agent 338, power quality type 2 agent 340, through a power quality type N agent 342. The letter “N” denotes that any number of PQI Agents may be created according to new PQI classes created or added.

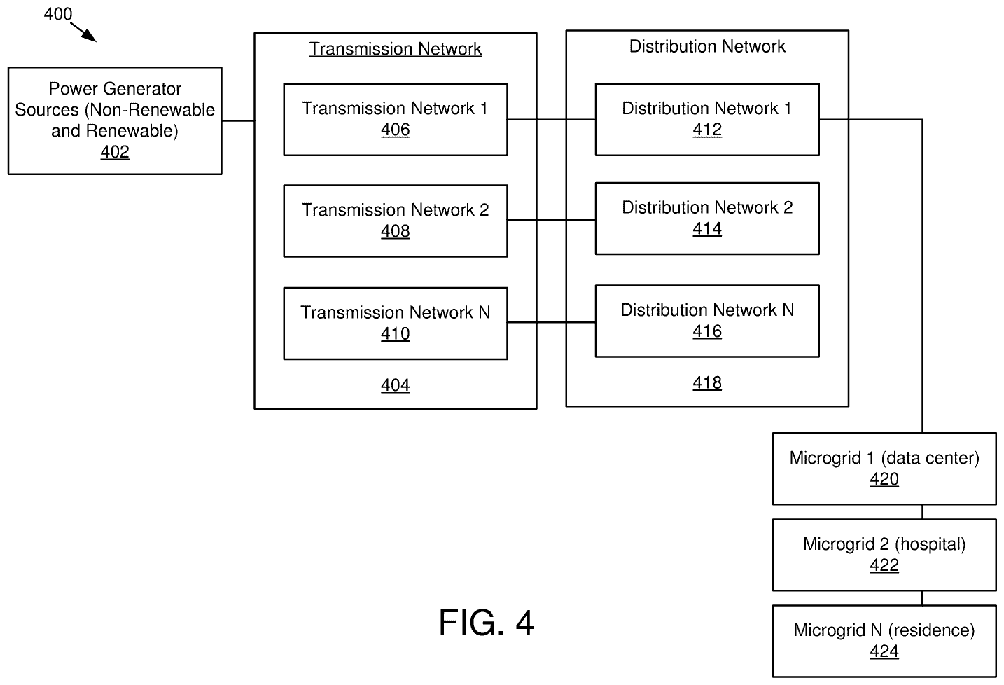

Referring now to FIG. 4, a typical environment of a power network is generally illustrated and designated by reference numeral 400. The power network 400 in some implementations my comprise power generator sources 402 (non-renewable and renewable), transmission network 404, distribution network 418, and microgrids “Microgrid 1” 420 (e.g. data center), “Microgrid 2” (e.g. hospital) 422, and “Microgrid N” (residence) 424. In a typical environment, power flow is from the power generation sources 402 through transmission networks 404 through distribution networks 418 to the microgrids 420, 422, and 424 illustrated. The transmission network 404 is illustrated with different transmission networks, including “Transmission Network 1” 406, “Transmission Network 2” 408, through “Transmission Network N” 410. The distribution network 418 is illustrated with different distribution networks, including “Distribution Network 1,” “Distribution Network 2,” and “Distribution Network N,” each supplying a different grid. As is well known, a microgrid 420, 422, or 424 is a self-contained electrical network that allows a facility to generate its own electricity on-site and use it when it is most needed. A microgrid 420, 422, or 424 is thus a type of distributed energy resource. A microgrid 420, 422, or 424 operates while connected to the utility grid or may operate in disconnected mode. When the grid goes down or electricity prices peak, microgrids 420, 422, or 424 respond. A microgrid 420, 422, or 424 co-locates electricity generation and consumption. Unlike the utility grid, which generates electricity in a centralized power plant and then distributes it along hundreds of miles of transmission lines, a microgrid 420, 422, or 424 generates electricity on-site. Microgrids 420, 422, or 424 may use renewables such as solar panels. Alternatively, microgrids 420, 422, or 424 can incorporate battery systems to store electricity and deploy it during outages or when grid demand spikes. Other forms of renewable energy may include hydropower, wind, geothermal, and biomass. As power reliability and resiliency are imperative in data centers and hospitals, monitoring power quality issues in microgrid distribution is critical.

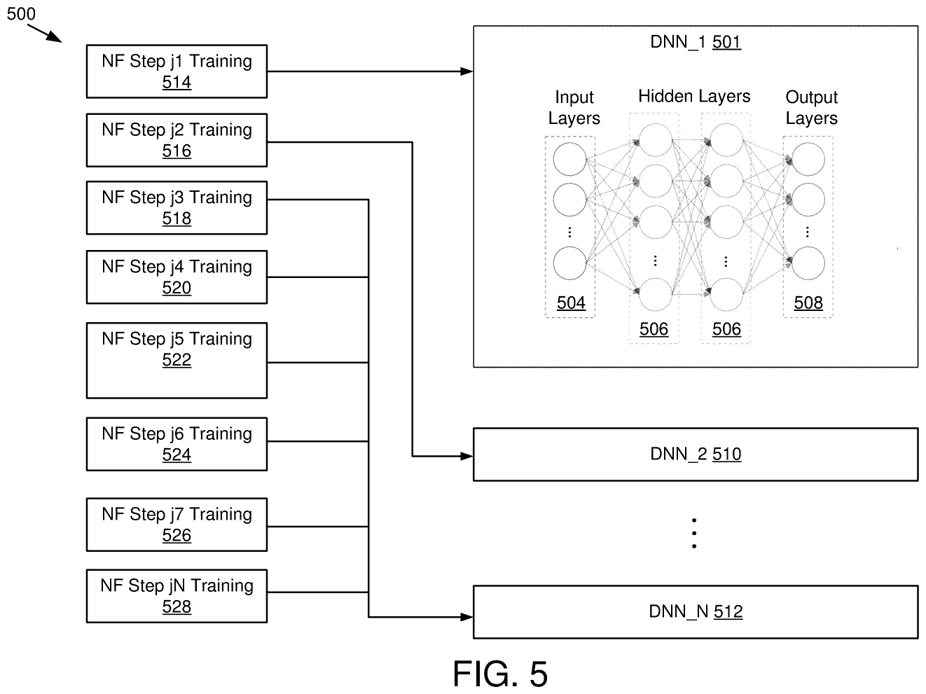

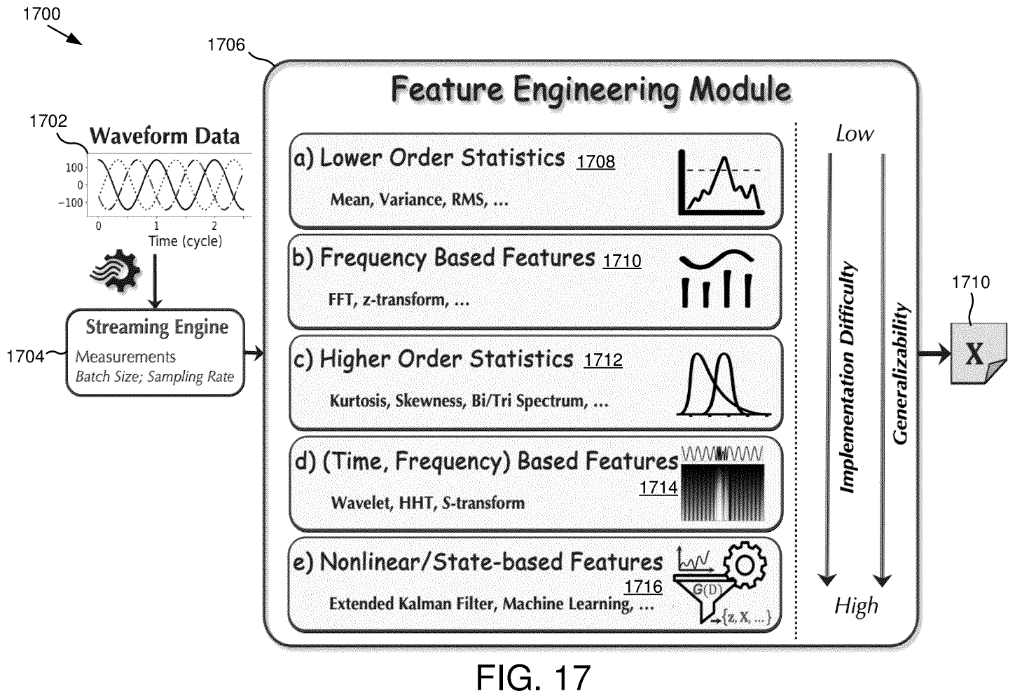

Referring now to FIG. 5, an example architecture of and steps for training of the normalizing flow models is illustrated and designated generally by reference numeral 500. The architecture and steps learn the nonlinear distribution of the features for each class of power quality (PQ) issues including what is “normal.” The architecture uses simple deep neural networks (DNN) for every step in the normalizing flows system 500. The DNNs are a subcomponent of the normalizing flow model 500. The normalizing flow model combines a neural network (e.g., DNN 1 501) with a multi-stage normalizing flow to model conditional probability distributions p(y|x). The neural network outputs flow parameters conditioned on input x, enabling the flow to represent complex probability distribution over multidimensional y. With sufficient expressiveness, the normalizing flow can approximate arbitrary complex and nonlinear conditional distributions. The normalizing flows model is a core component, which is designed to learn how to map and transform simple probability/density distributions, for example, Gaussian, to actual (often very complex) probability distribution representing real-world data. The normalizing flow model 500 accomplishes this transformation by using a series of small, sequential steps that each consist of an invertible and differentiable mathematical transformation. If performed successfully, the chain of steps gradually and eventually can “connect” any sampled point in the latent (and simple) probability distribution, e.g., Gaussian distribution, to one unique point on the complex/messy appearing distribution that reflects the real-world data. For every step identified by “j” in the implementations illustrated here, the system assigns one unique neural network DNN_j, to try and learn (train) it during the training process. The complex/messy data distribution in this illustrated example may be a preset feature vector X (see FIG. 17), including a complex set of statistical attributes computed using waveform data for one (or more than one) classes of PQI. The vector X represents a snapshot of waveform data (and its statistical properties). Each of the DNNs, DNN_j (e.g., DNN_1 designated by reference numeral 501, DNN_2 designated by reference numeral 510, through DNN_N designated by reference numeral 512) is used to learn the transformative steps in the normalizing flows. As illustrated, in the normalizing flow (“NF”), each of the illustrated steps, step j1 through jN, are illustrated separately and designated by reference numerals 514, 516, 518, 520, 522, 524, 526, and 528. Each uses a DNN, for example, DNN_1 designated by reference numeral 501, DNN_2 designated by reference numeral 510, and DNN_N designated by reference numeral 512. Each DNN is illustrated by input layers 504, hidden layers 506, and output layers 508. In some implementations, the DNNs used may have between three to twenty layers. The hidden layers may be between 64 through 512 neurons. In some alternative implementations, flow-based diffusion models may be used. Flow-based diffusion models have the ability to model complex data distributions and their potential for anomaly detection. The flow-based diffusion models learn the distribution of normal power systems (e.g. data streams of voltage, current, frequency waveforms etc.), and when a deviation from the normal pattern occurs, such as voltage sag, swell, or harmonic distortion, the model reconstructs the data or the likelihood of the observation drops significantly, indicating an anomaly or a power quality issue. Using flow-based diffusion models accommodate the ability to scale the system architecture disclosed herein. It should be recognized that with faster sampling, power quality issues such as transients and short-lived anomalies can also be more easily observed, reducing the damage risk to expensive deceives in plants or fabs.

The data streams for the NF models may include data on voltage, current, equipment, operational state, vibration and acoustics, local and component-level temperature, upstream power quality data (in connected systems) external data etc. Equipment operational stats and control signals are critical as the precise operational state or cycle of a machine (e.g., idle, startup, process execution, shutdown) provides a direct label for the expected power signature. A voltage sag that occurs every time a plasma etcher's RF generator starts is not an anomaly to be flagged but a characteristic to be learned. This data may be obtained from programmable logic controllers (PLCs), SCADA systems, equipment log files, or control signals for components like variable frequency drives (VFDs) and allows the model to differentiate between normal operational events and genuine PQIs. This data assists with the root case analysis and inference, by enabling highly accurate “normal behavior” models (the PQI_class) for each specific machine state, dramatically reducing false positives. When a true anomaly is detected, correlating it with the machine's state provides an immediate first-level diagnosis. For example, “voltage sag detected during pump-down phase.” This data directly addresses the challenge of modeling complex, non-linear loads like VFDs (Variable Frequency Drive) and arcing devices.

The data on vibration (from an accelerometer) and acoustics is critical as mechanical events are precursors or direct causes of electrical anomalies. For example, a failing motor bearing causes a distinct change in vibration before the motor's power draw becomes erratic or it fails. Arcing, a source of harmonics and transients, creates a unique acoustic and high-frequency vibration signature. By using this data, the models can learn to associate specific vibration or acoustic signatures with PQIs like harmonics, transients, or incipient motor failure. In this scenario, the root cause analysis can determine from viewing even harmonics and the vibration sensor on a motor simultaneously showing a spike at a corresponding frequency, that here is likely a mechanical issue in the specific motor with much higher confidence.

The data on local and component-level temperatures (from thermocouples or infrared (IR) sensors (e.g., sensors 204 in FIG. 2) embedded within equipment enclosures or monitoring critical components like power supplies and drive controllers) may include overheating as an indicator of electrical stress. Loose connections, failing components, overloaded circuits, and poor ventilation all manifest as increased temperature before a catastrophic failure. In such scenarios, the models learn the correlation between a gradual rise in temperature and the subsequent onset of a PQI. A rise in Total Harmonic Distortion (“THD”) combined with a temperature spike on a specific power converter or server power supply provides a clear, actionable insight for maintenance teams.

Data on system-level and environment context (obtained from a dedicated power quality monitor installed in a facility) is critical because the model determines the origin of the PQI and learns the quality of the power entering the facility or the local subsystem. In this instance, the PQI is classified as “internal” versus “external.” For the root cause analysis (RCA), the model accurately assigns responsibility, by preventing incorrect flagging of a piece of SEMI F47-compliant equipment as faulty when it correctly rode through a sag originating from the utility. External factors can impact the grid, as in lightning strikes. Data on process fluid and gas dynamics (from sensors for flow rate, pressure, and chemical concentration) is critical in semiconductor and medical equipment, electrical components supporting physical processes, for example, the performance of pumps, valves, and mass flow controllers is directly tied to power consumption. An anomaly in the current drawn by a coolant pump may be correlated with a simultaneous drop in the coolant flow rate or a pressure warning. With this data, the model identifies the issue not just in the pump's electrical system but identifies a potential physical problem (e.g., a blockage or leak). Data on humidity is critical as high humidity can lead to condensation, decreased insulation resistance, and eventually, arcing or short circuits. In this scenario, for the root cause analysis of intermittent, difficult-to-diagnose faults, adding humidity as a feature can reveal correlations that are otherwise invisible. A series of unexplained transients might be found to only occur when ambient humidity exceeds a certain threshold, suggesting an insulation problem.

The hidden layers 506 transform the input data into a representation used to make accurate predictions. The hidden layer 506 are the intermediate processing stages, extracting features and patterns from the input data streams, and then passing this processed information to subsequent layers. The output layers 508 provide the output to the facilities being monitored.

It should be recognized by those skilled in the field that the list described here contains only the most frequent reasons for emergence of harmonics. It should also be recognized that other reasons can cause the power quality issues (PQIs), which fall within the scope of the invention described here.

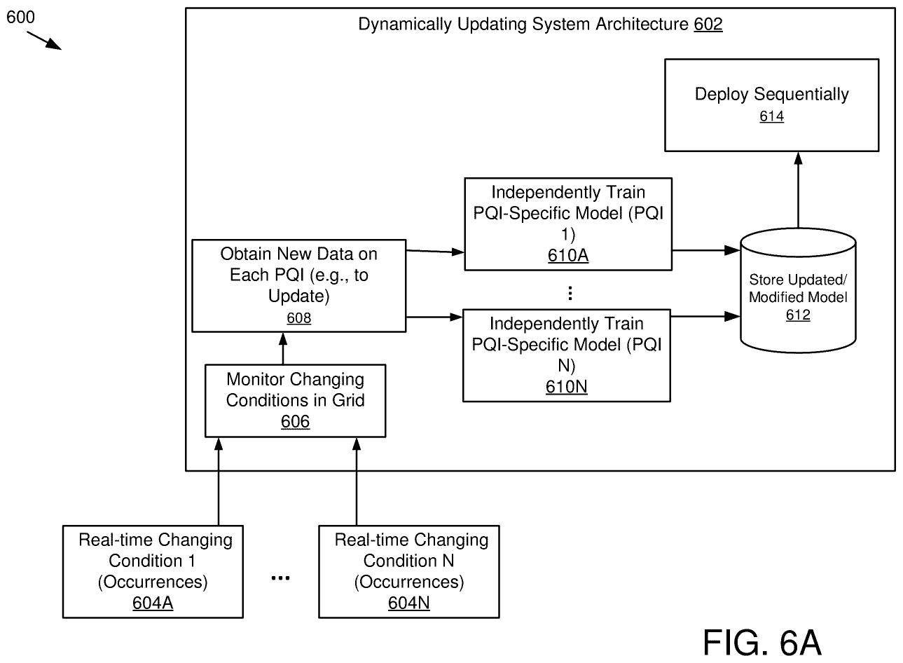

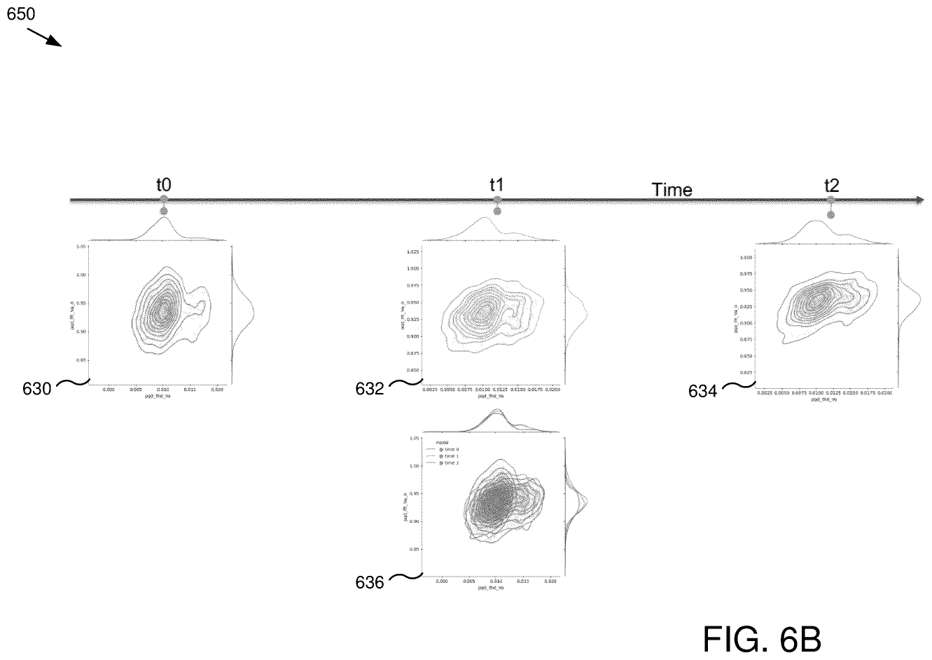

Referring now to FIG. 6A, the high-level block diagram of system architecture for the AI models to dynamically update on new data to adjust to the constantly changing conditions of the grid is illustrated generally at 600. The model has the ability to dynamically update its learned distribution over time. Specifically, the model can be incrementally updated by training on new data without requiring access to, or merging with, the original training data. The dynamically updating system architecture 602, starting from a predesignated time may start obtaining data from different hardware sources that provide data on real-time changing conditions, from 1−N, due to occurrences of power quality issues. These different hardware sources are designated by reference numerals 604A through 604N. The dynamically updating system architecture 602 includes software modules 606 to monitor changing conditions being present in the local power grid. Output from these modules 606 is transmitted to a software module 608 that obtains new data on each PQI, for updating the AI models. The dynamically updating system architecture 602 includes modules 610a through 610N that independently train the PQI-specific models, for example, for PQI type 1, through PQI type N. The updated modified AI models are stored in storage facility 612, from which the AI models are sequentially deployed.

Referring to FIG. 6B, the high-level block diagram illustrates an example scenario of how the AI model tracks changing conditions illustrated generally by reference numeral 650. The AI model continuously monitors and adapts to changing power conditions, learning new operational baselines over time. The graphical image at “t0” illustrating an example starting image is designated by reference numeral 630. A subsequent example image at a later time “t1” is designated by reference numeral 632. Another change in the example image at another later time “t2” is illustrated and designated by reference numeral 634. The final example image illustrated and designated by reference numeral 636 shows harmonic distortion. The AI model adapts to new baselines, accommodating a minor total harmonic distortion (THD) increase from 1.3% to 1.5%, while establishing stricter voltage magnitude variation limits.

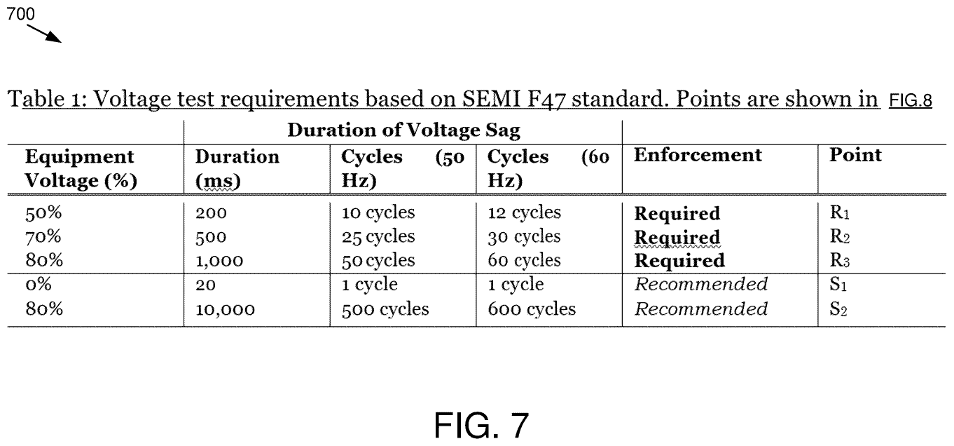

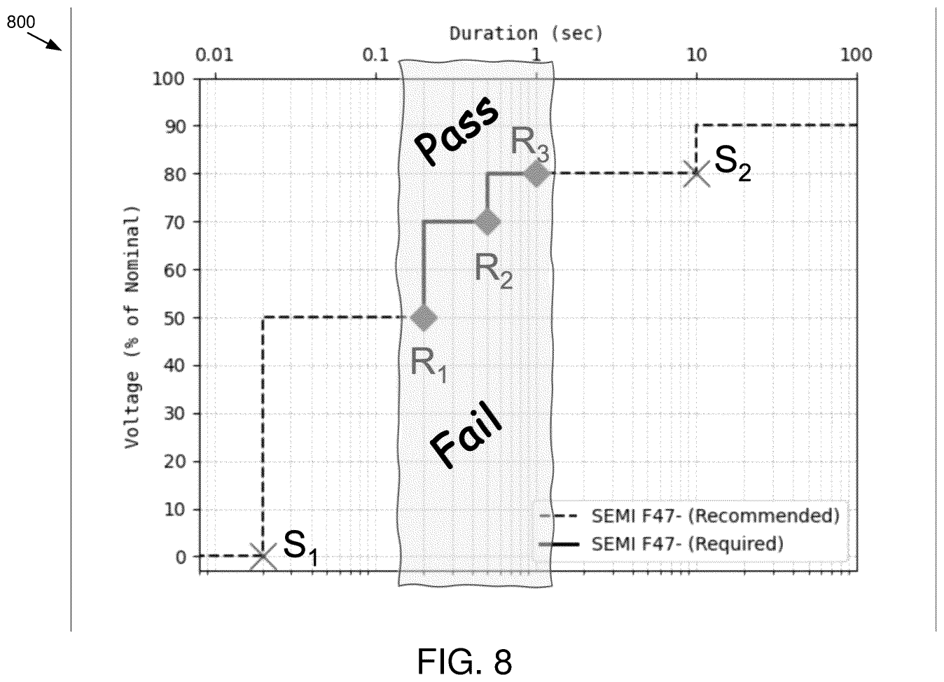

Referring to FIG. 7, illustrates a table (Table 1) with voltage test requirements based on SEMI F47 Standard designated generally by reference numeral 700. The points are shown FIG. 8 that illustrate the duration of voltage sag. It should be recognized by those skilled in the art that the SEMI F47 is a voltage sag immunity standard that was first introduced in 1996. Driven by the stringent needs of semiconductor manufacturing facilities, SEMI F47 standard requires machines used by semiconductor fabs to be immune to otherwise critical voltage sag scenarios listed in table 1. Ever since its inception, there have been multiple revisions to SEMI F47 using feedback from engineers, globally. The latest version, SEMI F47-0706, which was reapproved in 2012 (SEMI F47-0812) has been implemented and adopted by numerous industries worldwide. Recent studies estimate that as a result of implementing the SEMI F47 standard in PQ monitoring, sensitive devices in fabs continued their operations. Therefore, it has saved manufacturers hundreds of millions of dollars by avoiding disruptions in production processes. The table 700 (Table 1) illustrates equipment voltage, duration, cycles, enforcement, and points. FIG. 8 illustrates the SEMI F47-0706 standard (most recent version) that is required (♦) and recommended (X) duration for different values of voltage sag. Adoption of this standard by the semiconductor manufacturing plants have saved hundreds of millions of $USD by mitigating interruptions due to voltage sags in their fabs.

As described here, there are significant challenges in power quality monitoring. A review of technologies used to improve power quality across different industries illustrates a high complexity of the PQI family, for example, because of multi-timescale resolution, stationary non-stationary signal properties, etc. The PQ models described here vary to perform the end-to-end pipeline of power quality issue monitoring. The Intelligent AI-enabled system 114 described here addresses these issues efficiently and reliably, since intelligent agents infer in real-time finer versus coarser sampling rate to flexibly adapt to severity of waveform data disturbance (adaptive sampling).

Referring now to FIG. 9, the Intelligent AI-enabled system 114 (FIG. 1) with the multi-tier structure of PQ Agents (FIG. 2) is illustrated generally at 900. The streaming data 902 is first reviewed and a qualification score is computed for the model, as represented in the block 904, designated by reference numeral 904. If the model is determined as qualified to determine the power quality issue (PQI) class, the Intelligent AI-enabled system process 900 transmits the data to compute the generic anomaly score, as represented by block 910. In the event, it is determined that the model is unqualified to detect power quality issues, as represented by block 914, the Intelligent AI-enabled system process 900 signals a log/store 916, and in some implementations forwards this determination to the root cause analysis (RCA), represented in this figure by reference numeral 924. At block 910, if the Intelligent AI-enabled system process 900 determines that there is a power quality issue, a signal is passed to a decision block 912, which inquires if a power quality issue is identified? If the answer is negative, a signal from this decision block 912 is also forwarded to the log/store 916, and the determination is passed to the root case analysis (RCA) 924. An affirmative signal from the decision block 912, which indicates that there is a power quality issue identified, is passed to block 918 for classifying the power quality issue and then block 920 for characterizing the power quality issue. The output from the blocks 918 and 920 are transmitted to the power quality issue event handler 922, which creates, logs, and escalates the issue following preconfigured safety and/or operation logic. A log as illustrated includes a PQI class, notation of Harmonics C3, THD of % 12, Critical Level of “Medium,” and an instruction to “Escalate” with a “Name” of who the alert should be escalated to.

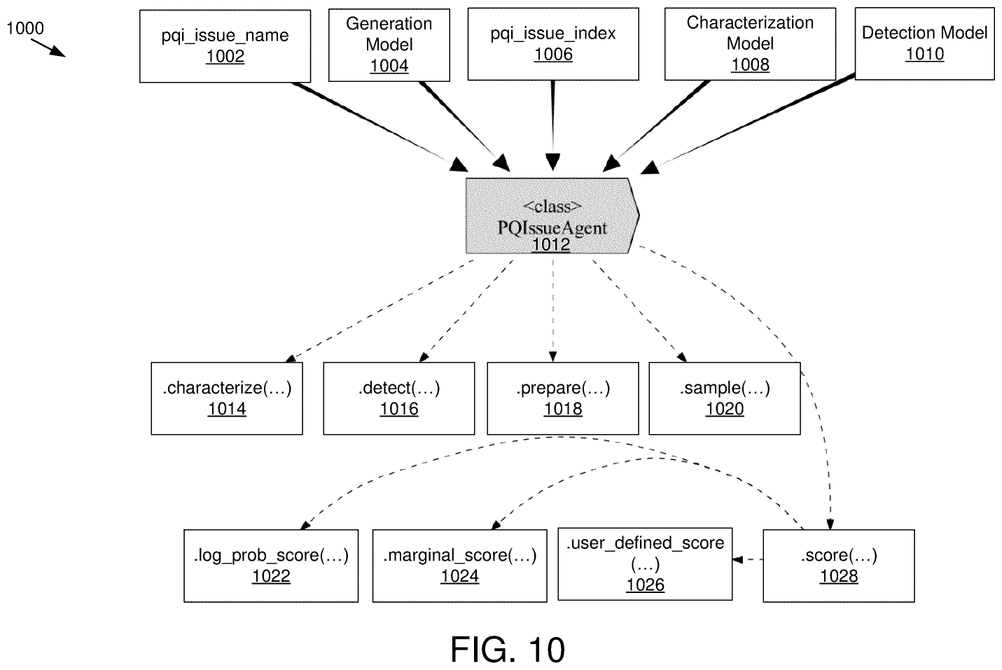

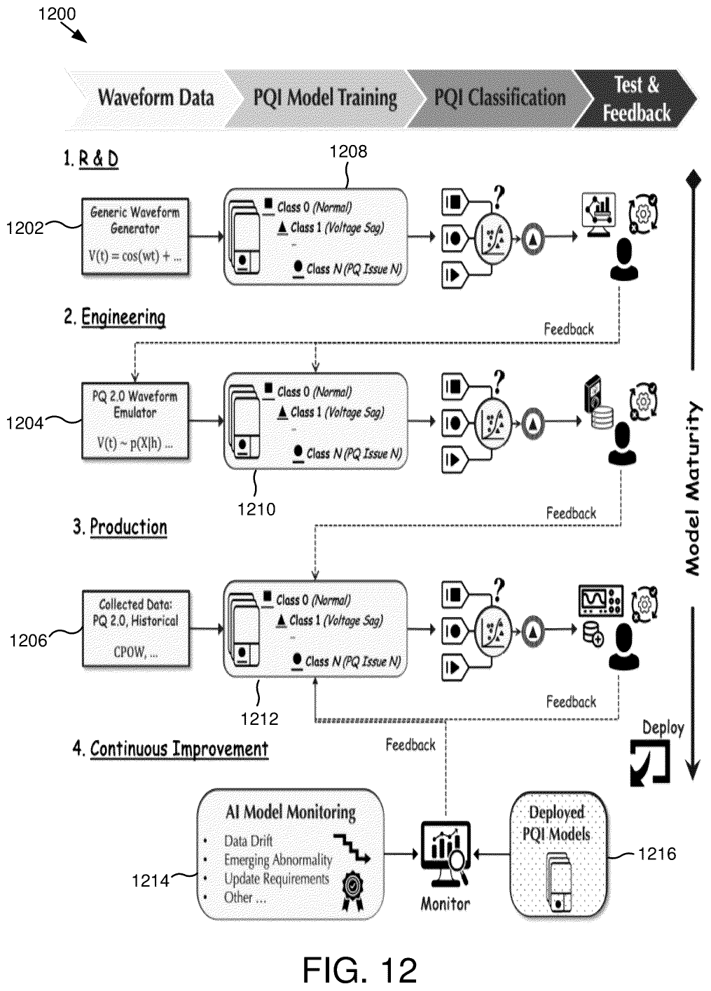

Referring now to FIG. 10, the overall schematics and architecture of the AI-enabled intelligent system 114, are illustrated here, and represented by reference numeral 1000. For every unique power quality issue, an instance of ‘PQIssueAgent( . . . )’ designated by reference numeral 1012 is programmatically constructed. FIG. 10 illustrates an example schema of PQIssueAgent ( ) 1012, which includes inputs and methods as illustrated. The inputs into the <class>PQIssueAgent 1012 include pqi_issue_name 1002, generation model 1004, pqi_issue_index 1006, characterization model 1008, detection model 1010. The outputs from the <class>PQIssueAgent 1012 include.characterize( . . . ) 1014, .detect( . . . ) 1016, .prepare( . . . ) 1018, .sample( . . . ) 1020, and .score( . . . ) 1028, which further generates values in.log_prob_score( . . . ) 1022, .marginal_score( . . . ) 1024, and .user_defined_score( . . . ) 1026. This figure illustrates the end-to-end process pipeline that has been built to define and train a set of PQI ‘Knowledge Base.’ (see FIG. 12). In some implementations, the main components of this knowledge base may include the following:
1. The reference set of PQI classes, Q,

$$\begin{matrix}Algorithm 1 & \\ 𝒫𝒬 = \{ {h}_{0} , {h}_{1} , … , {h}_{G} \} with & ( 1 )\end{matrix}$$

$${h}_{0} {=}^{Δ} {PQI}_{0} \to No PQ issue ( Set to predefined normal behavior ) ,$$

$${h}_{1} {=}^{Δ} {PQI}_{1} \to 1 st PQ issue to be monitored ,$$

$${h}_{2} {=}^{Δ} {PQI}_{2} \to 2 nd PQ issue to be monitored ,$$

$$⋮$$

$${h}_{G} {=}^{Δ} {PQI}_{G} \to G - th PQ issue to be monitored .$$

2. [Input] PQI class name and class index.
3. [Input] Trained (and validated) models to carry out three tasks: a) PQI detection (.detect( ), b) PQI characterization (.characterize), and c) PQI generation (.sample).
4. [Method] .prepare( ). Fetch and onboard input (trained) models for required tasks. Under-the-hood configuration may be implemented here to optimize online inference, logging, or thresholds, model performance.
5. [Method].detect( ). Given a new batch of data points, Xₙ, detect the existence of current PQI class.
6. [Method] .characterize( ). If PQI class is detected, use this method to perform characterization on the new batch of data Xₙ.
7. [Method] .score( ). Given a new batch of data points, Xₙ, apply anomaly scoring function to measure how close data resembles the expected behavior of current PQI issue class.
8. [Method] .sample( ), Apply a statistical sampling technique that is known to those skilled in the art, e.g., MCMC, to draw a certain number of points, Xₛₐₘₚₗₑ, from probability distribution given by the PQI generation model.

A basic schema to define PQI for a voltage sag is indexed below as class h. This bundle of data (and meta-data) should be used to communicate as API calls in different environments, e.g., model repository and deployment server set up to monitor and tackle voltage sag issue.

To compute a model qualification score, consider that the AI model was trained on historical datasets (e.g., voltage, frequency modes, window-based statistics, etc.). In the event of a new datapoint ingested from a streaming source, the AI model initially computes a generic ‘anomaly score’ to declare one of the following circumstances:
1. The AI model is qualified to detect the existence of any PQ issues. By way of explanation, new data is a candidate belonging to the distribution of training datasets used to build the AI model repository of all PQIs.
2. The AI model is unqualified to detect the existence of any PQ issues. By way of explanation, new data is considered an out-of-distribution data point. If continued, the current model is not confident in its PQI detection outcome.

This is an important feature in the Intelligent AI-enabled system 114 given the dynamic nature of factors that can influence the power network's behavior and ultimately different PQIs that may or may not emerge unbeknownst to the owners of the facilities experiencing the power disturbances or interruptions.

Once a PQI is detected, any particular one of the instantiated PQI agents proceeds to apply its inherited model to characterize the detected PQI. The Intelligent AI-enabled system 114 enables a flexible and plug-and-play framework in which different techniques, characterization models along with distinct ‘definition’ standards may be applied by an existing instantiated PQIssueAgent( . . . ), as illustrated in FIG. 10 to characterize a detected class of PQI. The challenge of detecting and classifying various types of power quality (PQ) disturbances in electrical power systems is well known to those skilled in the art, as these disturbances typically include events such as sags, swells, flickers, and transients, which can negatively impact the performance and reliability of electrical equipment. As described above, accurate detection and classification of these events are important for maintaining system stability and efficiency. It is known to use optimized variants of the discrete S-transform, called the Fast Discrete S-Transform (“FDST”), which allows for more efficient and accurate extraction of time-localized spectral features from power system signals. Features relevant to PQ disturbances may be extracted using the FDST. These features capture the time-frequency characteristics essential for distinguishing between different types of disturbances. The extracted features may be fed into any classification model that can output a probability score using input feature vector. decision tree-based classifier. which is trained to recognize and differentiate between various disturbances—both single and multiple simultaneous events. The decision tree approach enables fast and interpretable classification. This approach identifies individual disturbances as well as combinations or overlapping events and is effective at accurately detecting and classifying a wide range of PQ events, even when multiple disturbances occur simultaneously. The integration of the FDST for feature extraction with a decision tree classifier is advantageous in real-time monitoring and automated diagnosis of multiple and complex PQ disturbances.

To build a versatile ‘characterization’ unit efficiently, a clear understanding of various PQIs should be understood. For example, the “duration of a PQI (δτ)” is measured or estimated in the number of cycles or milli-seconds. To estimate δτ the system computes the start and the end time (cycle) for the event associated with an identified PQI as it occurs.

For the “Magnitude Drop/Increase,” the system assumes a variable of interest, e.g. voltage, which it utilizes as a ‘beacon’ to track and estimate its deviation from otherwise normal behavior (in waveform).

For the “Rate of Change of Deviation(s),” the system defines a set of scalars, e.g. e (t), to compute temporal change of previously defined error. For instance, e(t)_{d̅e̅v}|f(t)−f₀| is used to store the deviation of actual system frequency, f\hat{ }(t), from the standard value f=60 Hz₀

For “Frequency Variations,” the system detects deviations and a rate of change of deviations. Of particular interest are questions such as flicker, transients, or super-imposed harmonics.

For “Phase Angles,” in a three-phase power system, alignment of voltage waveform data requires phase angles associated with each voltage (and similarly current) signal to remain untouched, e.g. ϕ_{a,b,c} {120, ⁰0⁰, 120⁰}. by estimating the relative phase angles and their respective configurations, the system points to a specific subset of PQI classes with particular characteristics, e.g., odd harmonics or even harmonics.

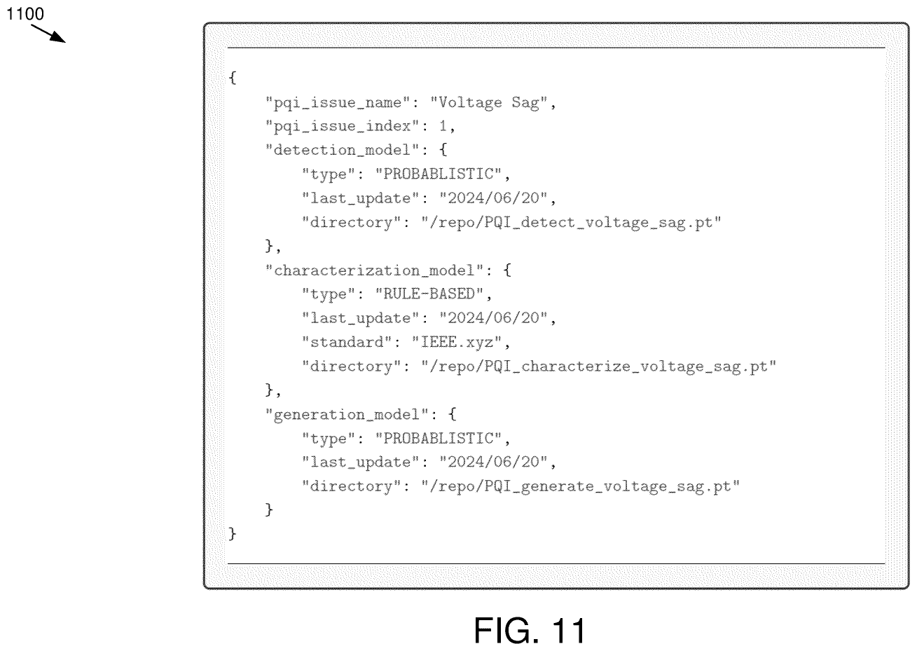

Referring now to FIG. 11, an example schema to instantiate a single PQI agent is illustrated generally and designated by reference numeral 1100.

Referring now to FIG. 12, the steps to build a knowledge base containing PQI behavior in waveform training data is illustrated generally and designated by reference numeral 1200. From the top to bottom, waveform data becomes richer and customized to the site or devices being monitored by the Intelligent AI-enabled system 114. The process flow 1200 includes step 1, including research and development, which includes a synthetic wave form generator 1202, the output from which is passed to PQI model training, which includes a class classifier 1208. The feedback from this phase is passed to engineering, where a PQ 2.0 waveform emulator 1204 emulates a richer more realistic signal and passes it for model training. The feedback signal from this phase is passed to the production phase 1206, which collects the real power grid data (including historical data). The output is passed to the classifier 1212 and ultimately, the feedback is passed to the next phase of continuous improvement. The AI monitoring module 1214 tracks the data drift, emerging abnormalities, and updates requirements. The PQ models are deployed, as represented by block 1216.

An example algorithm with example code to learn or update the behavior of a given PQI class is set forth below.

Algorithm 1: Pseudo-code to learn or update the behavior of a given PQI class.

```
function Learn_PQIssue_Data_Behavior (X, hᵢ, lrn_mode);
Input : X : feature vector
    hᵢ : PQ Issue class
    lrn_mode : Model training mode:
      lrn_mode ≡ UPDATE → Update the existing model
      lrn_mode ≡ SCRATCH → Build the model from scratch
Output: p(X|hᵢ)
// Start function
if lrn_mode ≡ SCRATCH then
  | p⁰(X|hᵢ) ← Initialize probability distribution for PQ class hᵢ;
  | p(X|hᵢ) ← learn_from_scratch(p⁰, X);
end
else if lrn_mode ≡ UPDATE then
  | p⁰(X|hᵢ) ← Import last probability distribution of PQ class hᵢ;
  | p(X|hᵢ) ← learn_to_update(p⁰, X);
end
// Return computed probability distribution function
return p(X|hᵢ);
// End function
```

It should be recognized that this example code may be used by the models to learn or update the behavior of any PQI class as the models are applied in different application environments or scenarios.

The Intelligent AI-enabled system 114 is configured to determine power quality anomaly scores. After making an initial determination that it is qualified to process new data points received, the Intelligent AI-enabled system 114 proceeds to compute an overall anomaly score. In operation, the value of this anomaly score is utilized by any automated ticketing system to warn of anomalous behavior observed in the sampled data being monitored. Alternatively, in other use scenarios, the anomaly module is independently deployed on historical data to help engineers perform root-cause-analysis for a logged event, for example, in a scenario where a device is shutting down without any visible warning signs.

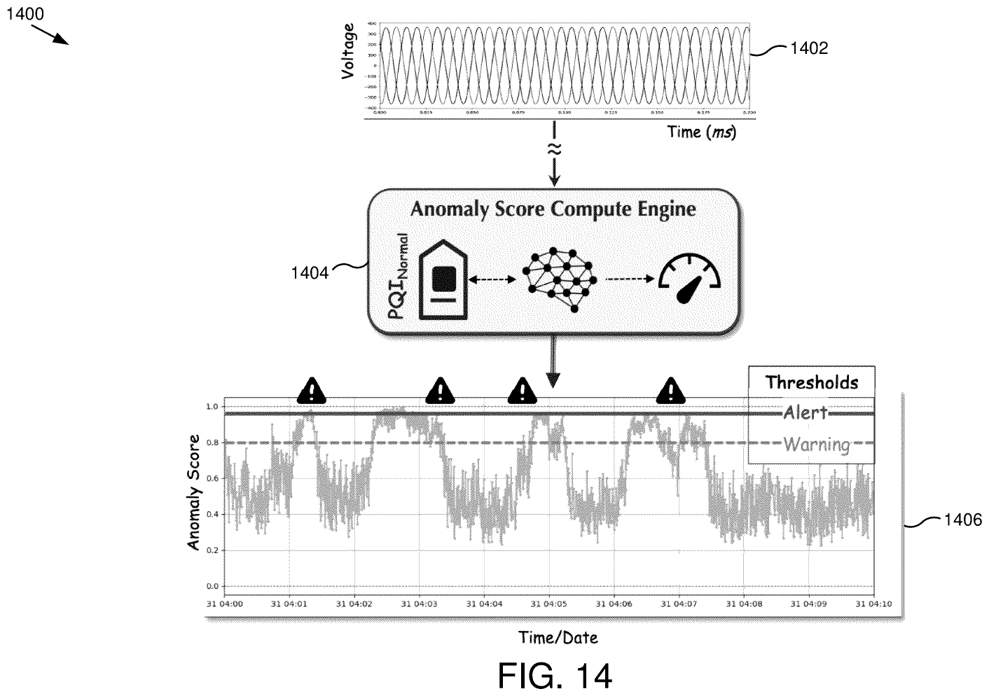

In some implementations, the definition of this numerical score can also be pre-configured by a human user. Alternatively, the Intelligent AI-enabled system 114 exploits the probabilistic nature used to learn every individual PQI and construct an anomaly scoring function according to a predefined template. In some implementations, the Intelligent AI-enabled system 114 applies a default template that uses the empirical Cumulative Distribution Function (“CDF”) constructed from the negative log-likelihood applied to samples drawn from the learned multivariate data distribution of every PQI class. It should be recognized that, by definition, the log-likelihood is the logarithm function applied to the probability density function. For instance, consider that X^{h}, X^{h}, . . . , X^{h}˜ Dₕ represents samples drawn from a learned data distribution of PQIₕ, where Dₕ is the learned multivariate data distribution for h-th PQI, and m is the number of samples drawn. Consider algorithms 2 and 3 described here and FIG. 14 to understand the mathematical formulation for the PQ anomaly score computed based on the negative log-likelihood and the empirical CDF.

The Intelligent AI-enabled system 114 considers and designates f(X|h) to represent the probability density function (PDF) of the learned multivariate distribution for PQI class h, and log f(X|h) as the log-likelihood. The Intelligent AI-enabled system 114 then constructs the scoring function using the Empirical cumulative density function (CDF) constructed from the negative log-likelihood values computed for all drawn samples

$${X}_{1}^{h} , {X}_{2}^{h} , … , {X}_{m}^{h}$$

such that:

$$S ( x ) = {\tilde{F}}_{h} ( x ) = \frac{1}{m} {\sum }_{i = 1}^{m} 1 \{ - log f ( {X}_{i}^{h} \vert h ) \leq x \} \qquad Algorithm 2$$

where \acute{F}ₕ(x) is the empirical CDF of the negative log-likelihoods for samples from the learned distribution, and 1{⋅} is the indicator function:

$${1}_{A} \{ η \} = \{ \begin{matrix}1 & if η ∈ A , \\ 0 & if η ∉ A .\end{matrix} \qquad Algorithm 3$$

In simple terms, the indicator function returns 1 if the condition inside the brackets is true and 0 otherwise. The scoring function 2 is normalized to produce score values 0≥ S≥1 with S=0 indicating ‘normal’ (and expected) conditions. In contrast, S=1 shares strong indication of abnormal behavior with large deviations of newly collected data Xt from what different PQI models have been trained on.

Referring now to FIG. 13, example queries that may be asked of the Intelligent AI-enabled system 114 are illustrated and designated generally by reference numeral 1300. Because of the probabilistic nature of every PQI model, a human engineer is capable of asking any number of complex questions, for example, an alarm for emerging PQI issues or whether or not any PQI model requires re-training. In some implementations, several query types of a first-order complexity may be posed by an engineer. For example, an engineer may ask a query of “how close the system is to its current state,” reference to a particular power system that is being monitored. In another example, a query may ask the Intelligent AI-enabled system 114 to “estimate a generic anomaly score.” Yet another query may ask the Intelligent AI-enabled system 114 “how confident are we in the computed anomaly score.” Yet another query may be “prepare a side-by-side plot of anomaly scores based on overall, harmonics, and voltage sag.

In some implementations, engineers may pose queries that are of a second-order complexity. For example, the query may indicate that “recently, the power grid in our neighborhood supports a few electric vehicle (EV) charging stations; do we need to update (re-train) existing PQI models detecting harmonics?”

In some implementations, engineers may pose queries of a third-order complexity. For example, an engineer may pose other queries, such as “our PQI model repository can only handle 3 PQIs; can we detect and warn for potential emerging PQ issues?” Further, “our engineering team confirmed emergence of a new PQ issue, Swell. Do we need to retrain all PQI models?” Accordingly, the Intelligent AI-enabled system 114 is configured to answer queries of varying complexity by expressing these queries as conditional probability computations that can be calculated by manipulating the trained models (as each model is a multivariate probability distribution over the features).

FIG. 14 illustrates the behavior of the anomaly scoring function S=0, represented generally by reference numeral 1400. This figure illustrates an anomaly score compute engine 1404 and the behavior of the anomaly scoring function S=0 is defined by the algorithm:

$$S ( x ) = {\tilde{F}}_{h} ( x ) = \frac{1}{m} {\sum }_{i = 1}^{m} 1 \{ - log f ( {X}_{i}^{h} \vert h ) \leq x \}$$

when it is applied to voltage data collected from the distribution network. In this illustrated example, the score exceeds the upper threshold on multiple occasions, indicating instances of abnormal power behavior identified by the model. These exceeding results suggest periods where the observed voltage and power quality patterns deviate significantly from expected norms, potentially signaling anomalies or unusual events within the power network.

The Intelligent AI-enabled system 114 includes various anomaly score templates to answer questions of different complexity levels. The Intelligent AI-enabled system 114 is configured to generate different anomaly scores intended for different purposes. The probabilistic nature of the unique modeling approach provides several benefits and flexibility to address different queries asked by SMEs. A few examples are shown in FIG. 13. This figure illustrates an example of how to construct and formulate anomaly scores to address different sets of questions. Consider an example with three classes of power quality issues, PQIs, i.e.:

$$PQ = \{ {PQI}_{0} , {PQI}_{1} , {PQI}_{2} , {PQI}_{3} \} . \qquad Algorithm 4$$

Define left-hand-side [PQ]; A superset consisting of PQIs of interest along with normal behavior (PQI0)

The Intelligent AI-enabled system 114 always assigns normal (expected) n behavior to PQI₀. In some implementations, the Intelligent AI-enabled system 114 defines the basic anomaly score for every individual PQI class i as:

$${S}_{i} ( X ) for i = o , … , G . \qquad Algorithm 5$$

Define G: Total number of PQIs to be monitored

For every given i, the following is computed:

$$0 \leq {S}_{i} ( X ) \leq 1 \qquad Algorithm 6$$

$$\begin{matrix}fi & \\ {S}_{i} \to 0 & \begin{matrix}( low anomaly score ) ⇒ \\ Higher chance of X belonging to {PQI}_{i} ,\end{matrix} \\ {S}_{i} \to 1 & \begin{matrix}( high anomaly score ) ⇒ \\ Lower chance of X belonging to {PQI}_{i}\end{matrix}\end{matrix} . \qquad Algorithm 7 and 8$$

By computing PQI-aware an anomaly score for every individual class, the system 114 proceeds to derive and compute ‘higher order’ scoring functions, which ultimately can answer more complex questions as described below with reference to FIG. 14. For example:

“Overall, is our PQ system currently operating within normal (and expected) condition range?”

“Compute the maximum anomaly score and which class it belongs to for a new data point Xn?”

“Is there support for potentially an emerging new class of PQI?”

“Does our entire set of PQI models need to be re-trained (or updated)?”

“How can we be sure when to update the reference model of the normal behavior, PQI₀?”

For PQ issue detection, given that a viable anomalous behavior is triggered using computed scores as described above, the Intelligent AI-enabled system 114 proceeds to identify the PQ issue (or issues) that exist in collected data. In other words, anomalous behavior may be defined by operators or engineers in multiple ways, i.e. deviation(s) from a) preset, b) historically normal, or c) nominal values given in implemented standards. Given the flexibility of the scoring of PQIs in the Intelligent AI-enabled system 114, relevant thresholds along with any suggested rules are computed into secondary scores. For any particular application, this process depends on the available and historical or synthetic PQ data provided to the models. The modeling approach is transparent and flexible, and switches easily between different anomaly scoring engine functions.

Referring now to FIG. 15, which illustrates a block diagram of the overall architecture of the PQI detection system designated generally by reference numeral 1500, which discloses how raw waveform data is processed, transformed, and interpreted as it goes through the different components of the architecture. In this figure, the architecture discloses a data preparation module 1501, a PQI-aware inference engine 1503, and a business-aware classification module 1505. In some implementations, the business-aware classification module 1505 refers to classification that not only identifies and categories power quality disturbances or anomalies but does so in a way that incorporates the business impact or priorities of the user or enterprise. The 3-Phase waveform data (obtained from data pipelines) disclosed herein is represented by reference numeral 1502 and is input into the streaming engine 1504. The streaming engine 1504 provides measurements, including batch size and sampling rate. The output from the streaming engine 1504 feeds into the data engineering component represented by block 1506, which represents data transformation, data imputation, and feature extraction functions disclosed herein. At this stage the raw data is transformed and features are extracted from the transformed data. The extracted features feed into the swift detection 1508, which includes checks for anomalies, using computationally lean non-ML algorithms. The configuration data 1510 for the data preparation phase includes hardware, standard data, meta data, and miscellaneous. The standard data may be automatically updated as standards change and/or are modified. The PQI-aware inference engine 1503 (or phase) executes vector features 1512, which determine if there are no power quality issues, represented by block 1514, or there are power quality issues. If there are no power quality issues, the system is aware that the power quality parameters are in a normal state. As illustrated, depending upon the specific power quality issue identified by the swift detection 1508, a qualified model is deployed. As illustrated PQI Class 1 model (on voltage sag), represented by block 1516 is deployed if a voltage sag issue in the waveform is identified. Alternatively, PQI Class 2 model (on harmonics), represented by block 1518 is deployed if a harmonics distortion is identified. Alternatively, the PQI Class N (on issue N), represented by block 1520 is deployed for other power quality issues that are detected. The business-aware classification module (or phase) 1505 includes the PQI classification decision process, which is represented by block 1522. The PQI classification decision module 1522 may classify a power quality issue in a prior classification or identify a misclassification. The detected PQI class(es) are displayed on monitor 1524. As one example, as illustrated a harmonics distortion is flagged in red. The illustrated display shows other detected PQI classes, including voltage sag, normal etc., with reference to a Nth PQI indicating that any number of PQI classifications are possible.

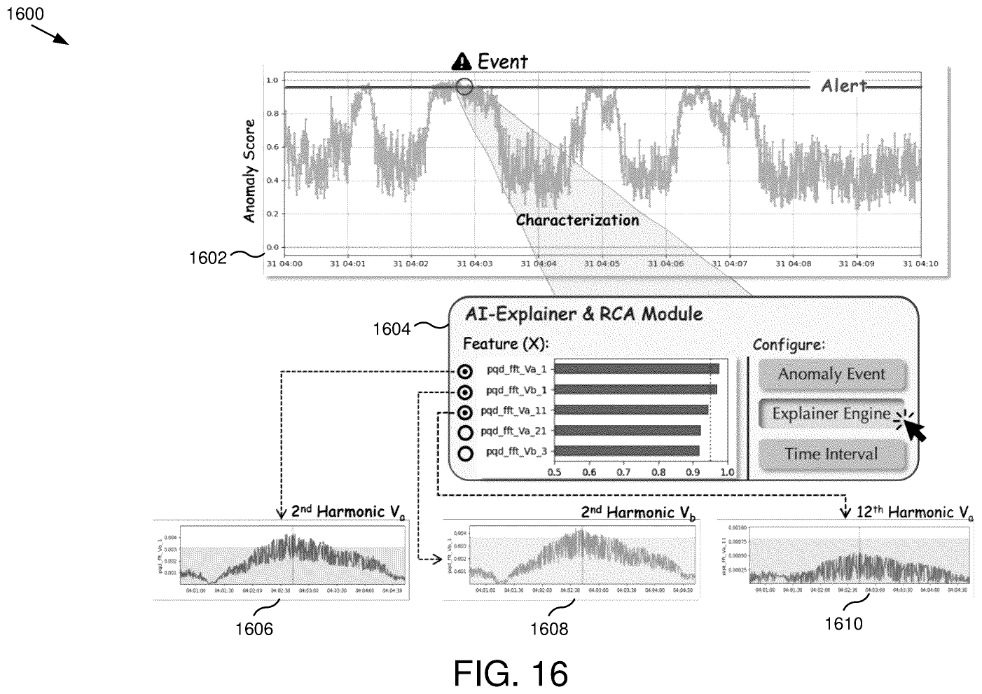

FIG. 16 demonstrates how a detected PQ issue is characterized by the specific data properties that contributed to triggering a high anomaly score. In this example, the identified PQ issue is “Even Harmonics,” characterized by a higher-than-expected value of the 2nd harmonic component. FIG. 16 illustrates an example of the characterization results generated by the Intelligent AI-enabled system 114. For a specific event accorded a high anomaly score, as represented by graph 1602, a user may select an AI-Explainer AI engine & RCA Module 1603, to discover the most relevant features and subsequently the PQI class causing the anomaly score to surpass the “alert” threshold. The red line in FIG. 16 indicates this “alert” threshold. The AI-Explainer AI engine & RCA Module 1603 is configured with the anomaly event, the explainer engine, and the time interval.

In some implementations, raw waveform voltage and current data continuously streamed from the measuring device is monitored and analyzed and scored for abnormalities. In this specific case illustrated, the model identified a graph representation 1606, a graph representation 1608, and a graph representation 1610.

The selection of the PQI classes as well as their indexing are configured to update and evolve in order to facilitate and expand consideration of any type of root cause analysis (RCA). In some implementations, the Intelligent AI-enabled system 114 is configured to include two distinct PQI classes for odd vs even harmonics (as opposed to assigning only one parent PQI class representing every possible configuration of harmonics). By structuring and configuring the Intelligent AI-enabled system 114 in this way significantly makes the root cause analysis tasks faster to perform.

Training and building PQ issue detection models are described herein. It should be recognized that detection of PQ issues (e.g., events, deviations, or disturbances) is a well-studied engineering and scientific field. Any of the well-known and accepted technological methodologies and detection frameworks may be used to detect power quality disturbances (PQD) especially in real-time. These known methodologies are implemented across several signal analysis, machine learning, and embedded system platforms. PQ issues may be detected by processing electrical signals (voltage and current) using a multi-stage approach, including acquisition and input data preparation, by use of sensors and instruments (e.g. PMUs, digital oscilloscopes, or smart meters), which capture real-world voltage and current waveform signals. The data acquired may be synthetic (simulated) or practical/measured (real disturbance signals from field environments). The data is preprocessed, which may involve tasks such as filtering, normalization, and noise mitigation to clean the raw signals. It should be recognized that this stage improves the signal-to-noise ratio, which is critical in real-time analysis. Signal analysis techniques convert signals from time domain to other representations (frequency, time-frequency etc., to enable better disturbance diagnosis). A number of methods are used to transform the signals to identify features like voltage sags, swells, transients, and voltage notches in real-time signal streams. Feature extraction and selection techniques involve computing numerical features from the transformed signals (RMS values, frequency deviations, notch depth/width/are, harmonic distortion) and removing redundant features via feature selection techniques, improving the speed and accuracy of the classification process. Techniques used for transformation include fourier transform (FT), short-term FT (STFT), wavelet transform (WT), gabor transform/stockwell transform, and Hilbert-Huang transform (HHT). Once features are extracted, pattern recognition algorithms are used to detect events and classify the type of power disturbance. It should be recognized any other well-accepted technique may be used.

There are several challenges in PQ monitoring and PQ issue detection in industrial settings, which demand high precision. For example, as is well-recognized, “real-time detection” is a particular challenge. Another challenge lies in the “nominal vs normal conditions,” which are set by existing standards. For any complex facility to maintain such conditions is a mammoth feat. For example, maintaining a nominal frequence (=60 Hz) in a semi-conductor plant may be a near-impossible task. However, an observed actual frequency (=60±0.5 Hz) may still be considered a ‘normal operating condition.’ The “historical data” is typically limited or non-existent. A lack of data on rare (adverse) events has great impact on a given site or manufacturing facility. The concept/data drift represents any data-driven PQ monitoring system that is inherently susceptible to data or model (concept) drift. In complex industrial facilities, there is no system that is monitoring operations. For example, if a semi-conductor plant makes updates to a few hardware units, ‘underlying’ (normal) behavior may change. Hence, the waveform data measured may follow a different statistical pattern ultimately triggering more false alarms, which are costly.

In modern facilities, it has become essential to maintain a “control tower view” on PQ health status at different locations as well as different times. To implement this, sophisticated data-driven models are required that have access to various PQ measurement devices. Extracting most important PQI and time/location of event in (near) real-time may provide significant business value to the operators.

External factors that should be considered include variables which impact the performance of PQ monitoring modules; however, they are not inherent to the internal operations of the facility under surveillance. For instance, extreme weather conditions, regional construction activities, or grid disturbances are a few examples.

With respect to featuring engineering possibilities, the Intelligent AI-enabled system 114 recognizes any data-driven PQI detection algorithm that requires a set of (measured and/or inferred) metrics representing the ‘current’ state of any system. Without any loss of generality, these metrics are labeled as ‘features,’ X, (see FIG. 15, X designated by reference numeral 1512. Due to the temporal nature of PQ systems, time series techniques may be employed to compute and extract temporal statistics as features to be used by any AI or ML model described here.

As illustrated in FIG. 17, for every query, the Intelligent AI-enabled system 114 computes a vector X, which includes a concatenated subset of features belonging to unique “families” (with similar characteristics, in nature).

$$x {=}^{Δ} {{⋃}_{f = 1}}^{F} {x}_{f} . \qquad Algorithm 9$$

Note: U denotes the Union operator from Set Theory

For a general case, the Intelligent AI-enabled system 114 expands the most comprehensive subsets of features described below (e.g., lower-order statistic) to include various subsets below:

$$X ≡ {X}_{LoS} ⋃ {X}_{HoS} ⋃ {X}_{FRQ} ⋃ {X}_{tFRQ} ⋃ {X}_{DFact} ⋃ {X}_{RoCh} ⋃ {X}_{LTNT} ⋃ {X}_{RULE} . \qquad Algorithm 10$$

Note: U denotes the Union operator from Set Theory

Expanding each term in algorithm 10, the system formulates the following algorithms 11-18 below.

$${X}_{LoS} {=}^{△} \{ {μ}_{φ} , {σ}_{φ}^{2} , {RMS}_{φ} , Max / {Min}_{φ} , … \} , \qquad Algorithms 11 - 18$$

$${X}_{HoS} {=}^{△} \{ {Kurt}_{φ} , {Skew}_{φ} , … \} ,$$

$${X}_{DFACT} {=}^{△} \{ {C}_{FF , φ} , {C}_{DF , φ} , {C}_{IF , φ} , {C}_{CF , φ} , {THD}_{φ} , {TDD}_{φ} , {IHD}_{φ} , … \} ,$$

$${X}_{FRQ} {=}^{△} \{ {FFT}_{φ} , z - {Transform}_{φ} , … \} ,$$

$${X}_{tFRQ} {=}^{△} \{ {HHT}_{φ} , {STFT}_{φ} , {ST}_{φ} , {WT}_{φ} , {GT}_{φ} , {CT}_{φ} , … \} ,$$

$${X}_{RoCH} {=}^{△} \{ d ( \cdot ) / {dt}_{φ} , … \} ,$$

$${X}_{LTNT} {=}^{△} \{ {F ( \cdot )}_{φ} , … \} ,$$

$${X}_{RULE} {=}^{△} \{ {〈 {Rule}_{1} 〉}_{φ} ⇌ {H ( \cdot )}_{φ} , … \} .$$

Theoretically, waveform signals representing any standard PQ standard may typically be modeled using a (finite) set of a priori known parameters characterizing periodicity and a quasi-equilibrium status, i.e., constant frequency, voltage magnitude, or invariant (waveform) phase angles. For example, for a balanced operation of a three-phase system, the system generates:

$$ℳ = \{ {f}_{0} , {V}_{t} , {ϕ}_{a} , {ϕ}_{b} , {ϕ}_{c} \} . \qquad Algorithm 19$$

Here, f₀, V₁, and ϕ denote, respectively, voltage nominal frequency, total voltage magnitude, and phase angles. As shown in FIG. 17, an AI engineer may opt in/out of subset of families of feature extraction techniques to balance the “compute cost” with the level of sensitivity, accuracy, or criticality of the mission mandated by operating/business requirements. A list of features may include “lower order statistics (LoS),” designated by reference numeral 1708, examples of which are Mean, variance, RMS, Peak, Zero-crossings. In some implementations, the list of features may include “frequency based features” (FRQ), designated by reference numeral 1710, which employs information extracted from signals processed only in the frequency domain, e.g. FFT. Yet another feature is “higher order statistics (HoS),” designated by reference numeral 1712, which illustrates that example metrics are Skewness and Kurtosis, which can be used to detect PQIs subjected to transient behavior. Other features include (Time, Frequency) Based features, designated by reference numeral 1714, examples of which are Wavelet, S-transform (Stockwell transform), and Hilbert-Huang Transform (HHT), which are known in the field. In some implementations, other features may include “nonlinear and latent-state-aware features (LTNT),” designated by reference numeral 1716, examples of which include Extended-Kalman Filter (EKF), features constructed by machine learning models, Empirical Mode Decomposition (EMD), etc. In some implementations, the features may include “rule-based and indicator features (RULE).” While this category may not be hard to compute, it is an important medium for infusing information by business and/or SME in the overall task of PQI classification. For example, a feature variable may be of Boolean type whose value can be ‘True’ or ‘False’ to indicate whether the device being monitored has been subject to a calibration, recently.

For baseline training, the goal is to train the Intelligent AI-enabled system 114 such that it learns the ‘normal behavior’ using any available historical (waveform and/or aggregated) PQ data. Subject to data availability, timescale (e.g., 12 hours, 1 day, or one week), waveform (vs RMS values), and multi-resolution data may be considered in formulating and setting up the training instructions.

For classification metrics, in the Intelligent AI-enabled system 114, the detection module ultimately returns a class label denoting a PQI class (in addition to a class without any PQI issues, i.e., PQI₀ Normal behavior). In the remainder, the Intelligent AI-enabled system 114 uses PQI context and defines relevant metrics in the end-to-end PQI classification pipeline.

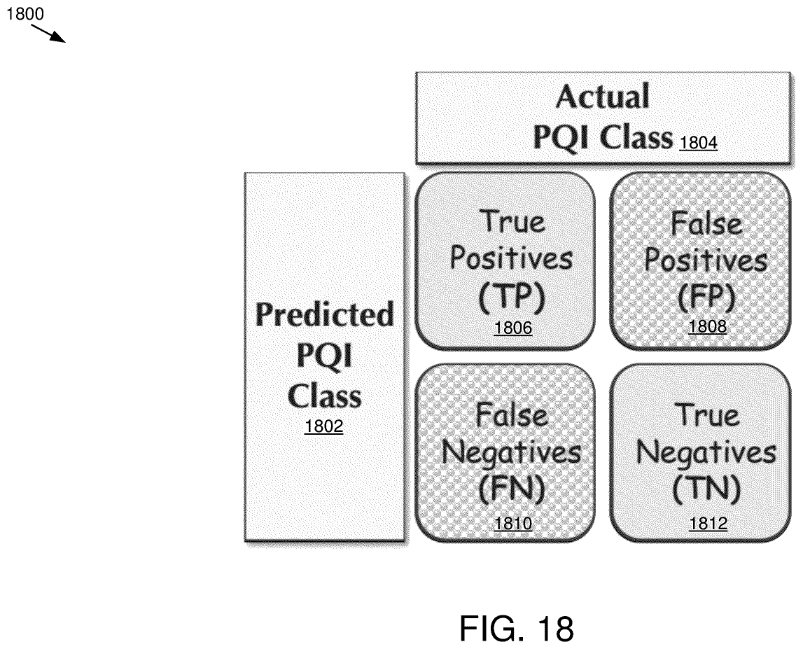

As illustrated in FIG. 18, in some implementations, a confusion matrix designated generally by reference numeral 1800 summarizes a model's performance on classification task. The basic version addresses the binary classification, yet the same concept may be extended to more than two classes, i.e., multi-class classification. A perfect classifier would only have nonzero values on the diagonal, i.e., true positives (TP) designated by reference numeral 1806 and true negatives (TN) designated by reference numeral 1812. Predicted PQI class is designated by reference numeral 1802, actual PQI class is designated by reference numeral 1804, false positives by reference numeral 1808, and false negatives by reference numeral 1810.

For precision and recall, in the context of PQI classification, the Intelligent AI-enabled system 114 assumes that its model is a binary classifier with PQI₀ denoting Normal and PQI₁ detected PQ issue, voltage sag. Consider the following definition:

$$Precision = \frac{TP}{TP + FP} , \qquad Algorithms 20 and 21$$

$$Recall = \frac{TP}{TP + FN} .$$

A high value of “Precision” indicates that a high percentage of all alerts raised by the Intelligent AI-enabled system 114 were correct, i.e., low FPR. Similarly, a high value of “Recall” denotes a low FNR. For example, if the cost of not detecting a true voltage sag, PQI₁, is high, it is important to have a low FNR and high Recall. In some implementations, a confusion matrix reduction method may convert a multiclass confusion matrix into an equivalent 2×2 binary confusion matrix, enables the user of binary classification metrics and tools like “ROC” (Receiver Operating Characteristic) curves and “AUC” (Area Under Curve) in multiclass classification scenarios, and facilitate consistent algorithm evaluation in real-world classification problems, for example, the net promoter score classification. This method groups multiple original class labels into two broad categories, creates a reduced confusion matrix (RCM) that matches the 2×2 format used in binary classification, allowing traditional binary metrics (accuracy, recall, specificity, AUC, etc., to be used in multiclass settings.

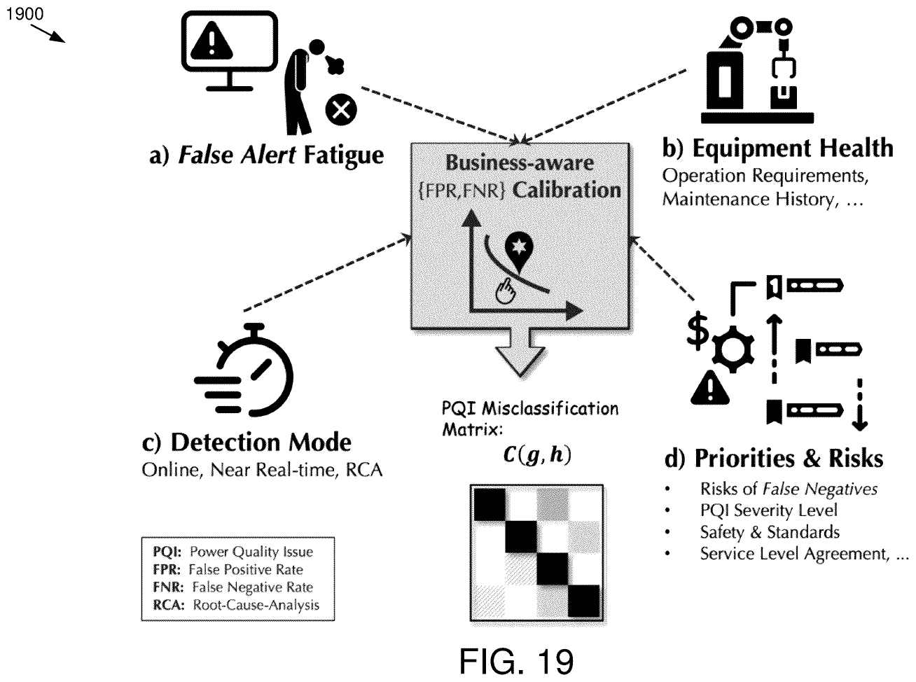

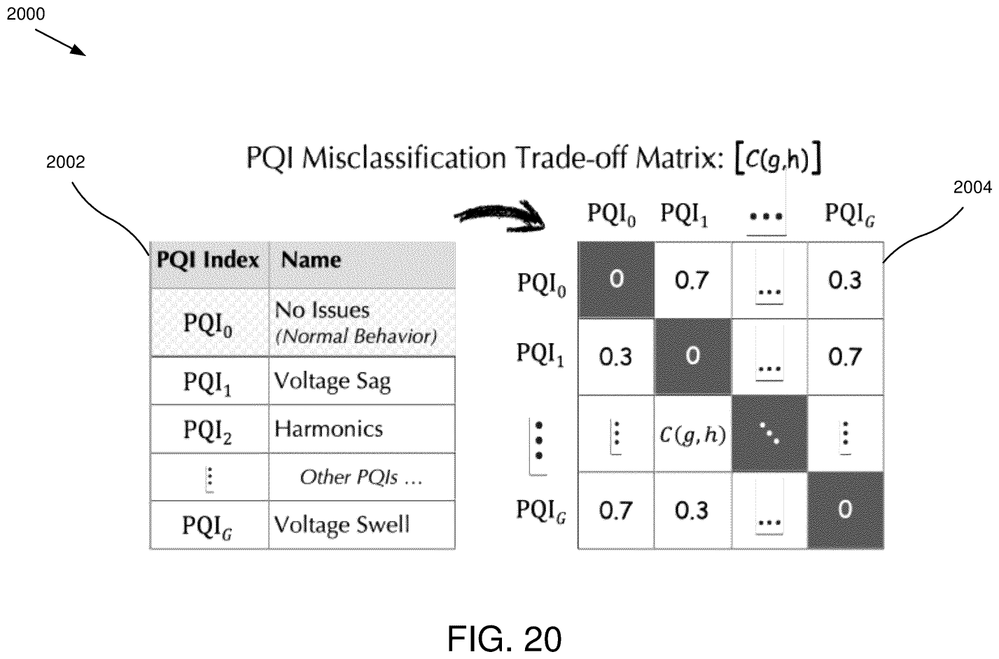

Referring now to FIG. 19, the Intelligent AI-enabled system 114 balances the cost of misclassification based on business priorities, as indicated by Algorithm 22 described below. It should be recognized that any data-driven inference model may make ‘errors’ after it is deployed to production and in operation, especially when it is subject to previously unseen (and/or noisy) data. FIG. 19 illustrates the schematics of factors required to build the misclassification cost matrix. The Intelligent AI-enabled system 114 intelligently uses a business-aware and flexible approach to infuse the trade-off amongst the financial loss, resulting from equipment interruption, the risk of damage to fabrication (fab) equipment, existing SLAs and quality control requirements, and the PQI detection mode via the [C (g, h)] matrix (also shown in FIG. 20).

As is well known, if an AI model's performance in training and/or production settings is suspiciously “good,” data scientists should consider the AI training procedure used and attempt to identify issues such as overfitting and label data leakage. Any of the well-known to those skilled in the art, overfitting refers to models effectively “learning the test set” through repeated evaluation or tuning on it, leading to overly optimistic performance. Label data leakage is a form of data leakage where label information inadvertently contaminates the training data or features, causing inflated evaluations. Both are internal evaluation failures that threaten the integrity and validity of ML performance claims, making it essential to avoid such failures, by using proper test sets and careful data construction.

The Intelligent AI-enabled system 114 implements Bayesian ‘Quadratic Discriminant Analysis’ (QDA) to infuse business priorities in returning detected PQI class index. The Intelligent AI-enabled system's 114 AI classification engine discriminates among G+1 classes of PQIs, therefore, the system first configures a misclassification cost matrix, [C_{g,h}]_{G+1 x G+1}, and proceeds to employ Bayesian QDA approach to return the PQI class, Ŷ.

$$\hat{Y} {=}^{△} {arg min}_{g = 0 , … , G} {{\sum }_{h = 0}}^{G} C ( g , h ) p ( X \vert Y = h ) P ( Y = h ) . \qquad Algorithm 22$$

FIG. 20 illustrates an example misclassification matrix 2000. To maintain notation consistency, in the formulations illustrated here, PQI₀ denotes “normal behavior.”

Here, C(g, h) is a square matrix denoting the cost of misclassification of given PQI classes (see FIG. 12). As illustrated by algorithm 22, the Intelligent AI-enabled system 114 follows a Bayesian framework and infuses prior knowledge on the occurrence frequency of different classes of PQIs via the prior probability distribution of including all classes of PQI, P(Y=h).

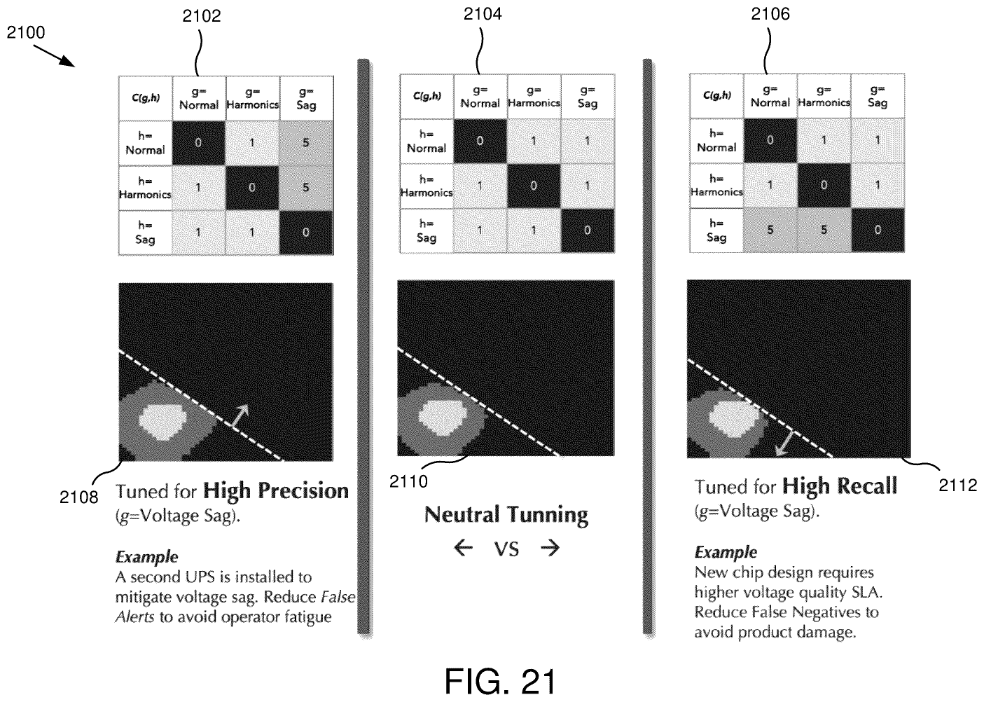

FIG. 21 illustrates an example fine-tuning of the classification decision boundary 2100 according to business and prediction accuracy requirements. Reference numerals 2102, 2104, and 2106 designate different charts. Reference numerals 2108, 2110, and 2112 designate different classification decision boundaries. Consider a trained (AI) model illustrated in the middle without any human infusing priorities in the model predictions. The left illustrates a higher precision for PQI class voltage sag. The right illustrates a higher recall for PQI class voltage sag. A user may calibrate the values in the matrix according to the optimal point needed to balance the accuracy requirements, alert-fatigue, sensitivity, or any hard/soft constraints.

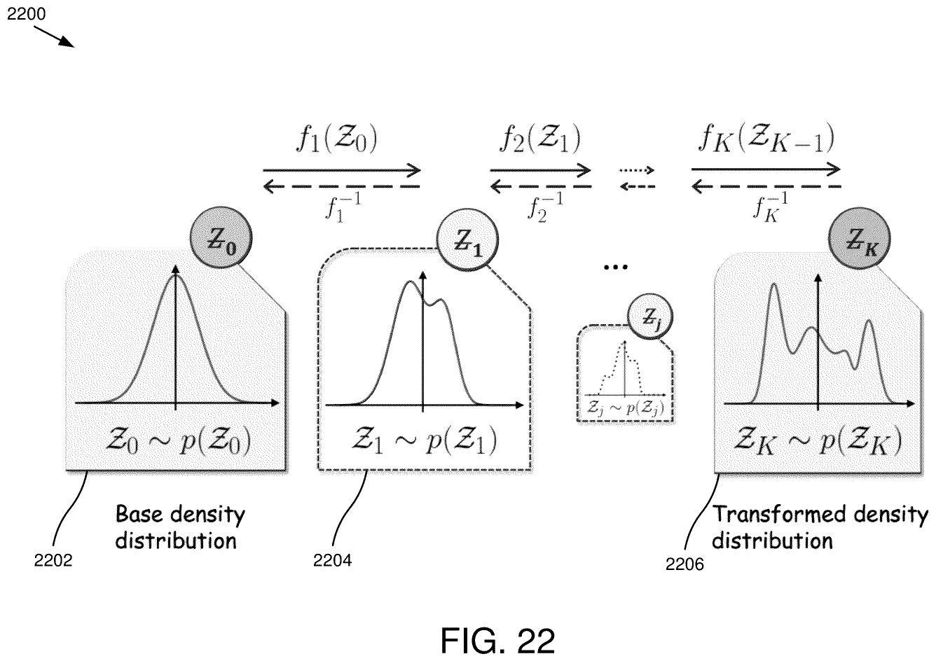

FIG. 22 illustrates instances for normalizing flows and probabilistic inference. The Intelligent AI-enabled system 114 employs a recent probabilistic framework called ‘Normalizing Flows’ (NF). A subclass of generative AI family, normalizing flows provides a flexible system to learn complex probability distributions. Normalizing-flow AI models have been shown to be applicable to different tasks such as probability density estimation and inference. Reference numerals 2202, 2204, and 2206 illustrate different graphical representations, including the base density distribution and the transformed density distribution.

It should be recognized that the current implementations are innovative end-to-end systems to employ NFs for the detection of PQ anomalies using waveform data. The definition and the inner-workings of NFs, are described here. It should be recognized that this technique and example applications are known to those skilled in the art.

Consider a scenario with a (random) variable. The fundamental logic behind NFs is to use transformation T and apply it to real vector(s) sampled from a ‘simple’ probability density distribution, p.

$$𝒳 = T ( u ) , where u ∼ p ( u ) . \qquad Algorithm 23$$

The main requirements to hold for transformation function T are:

Condition 1: Transformation function T must be invertible, i.e. T−1 should exist.

Condition 2: Both T and its inverse, T−1, should be differentiable.

In practice, however, the transformation function T is composed using a series of mini transformation functions, fⱼ.

$$T ≡ {f}_{1} \cdot {f}_{2} \cdot … {f}_{j} \cdot {f}_{K - 1} \cdot {f}_{K} . \qquad Algorithm 24$$

In Algorithm 24, every fi also respects the conditions outlined in conditions given above. For every inner transformation function, fj, there is

$${j}_{} = {f}_{j} ( {j - 1}_{} ) for j = 1 , 2 , … , K . \qquad Algorithm 25$$

Note that the two edge (boundary) points, i.e., Z₀ and Z_{K}, are, respectively, related to base distribution in latent space, e.g. Gaussian, and the feature vector (X) of the problem at hand in the following manner illustrated by the algorithm below:

$${( j = 0 )}_{} = u , \qquad Algorithm 26$$

$$𝒳 = {( j = K )}_{} .$$

The variable u is a random variable sampled from an a priori chosen distribution function called ‘based density distribution’ (see FIG. 22).

$$u ∼ p ( u ) = ( μ = 0 , {σ}^{2} = 1 ) . \qquad Algorithm 27$$

It should be recognized that the variables p (u) is not unique and, therefore, user can select from a wide selection of known (simple) functions (sometimes called priors) such as Gaussian distribution N. Ultimately, our goal is to learn the composed transformation function, T, successfully. In addition, there are other important and sometimes non-trivial configurations, e.g. the total number of fⱼ functions K or template of every fⱼ that has yet to be ‘learned’ from existing and training dataset. For example, in the illustrated scenario, with the relatively high dimension of input feature vector X, Deep Neural Networks (DNN) architectures that are known to perform efficiently to capture complex patterns in high dimensions are utilized. The definitions of form factors and common temporal features are indicated below.
1. Form Factor (FF): Of quantity X(t) defined in a temporal period [0, T]:

$${k}_{f} ≡ \frac{{X}_{RMS}}{{X}_{ARV}} = \frac{\sqrt{\frac{1}{T} {\int }_{0}^{T} {[ x ( t ) ]}^{2} dt}}{\frac{1}{T} {\int }_{0}^{T} \vert x ( t ) \vert dt} . \qquad Algorithm 28$$

2. Crest Factor (CF): Of quantity X(t) given in the period [0, T]:

$${c}_{r} ≡ \frac{1}{\sqrt{2}} \frac{{X}_{Peak}}{{X}_{RMS}} . \qquad Algorithm 29$$

3. Impulse Factor (IF): Of quantity X(t) given in the period [0, T]:

$${c}_{IF} ≡ \frac{{X}_{Peak}}{{X}_{ARV}} . \qquad Algorithm 30$$

4. Total Harmonic Distortion (THD): The ratio of the RMS value of all harmonic components (Vᵢ, i=2 . . . H) to the RMS value of the fundamental frequency (V₁),

$$THD ≡ \frac{\sqrt{{{\sum }_{i = 2}}^{H} {V}_{i}^{2}}}{{V}_{1}} . \qquad Algorithm 31$$

5. Distortion Factor:

$${c}_{DF} ≡ \sqrt{\frac{1}{1 + {THD}^{2}}} . \qquad Algorithm 32$$

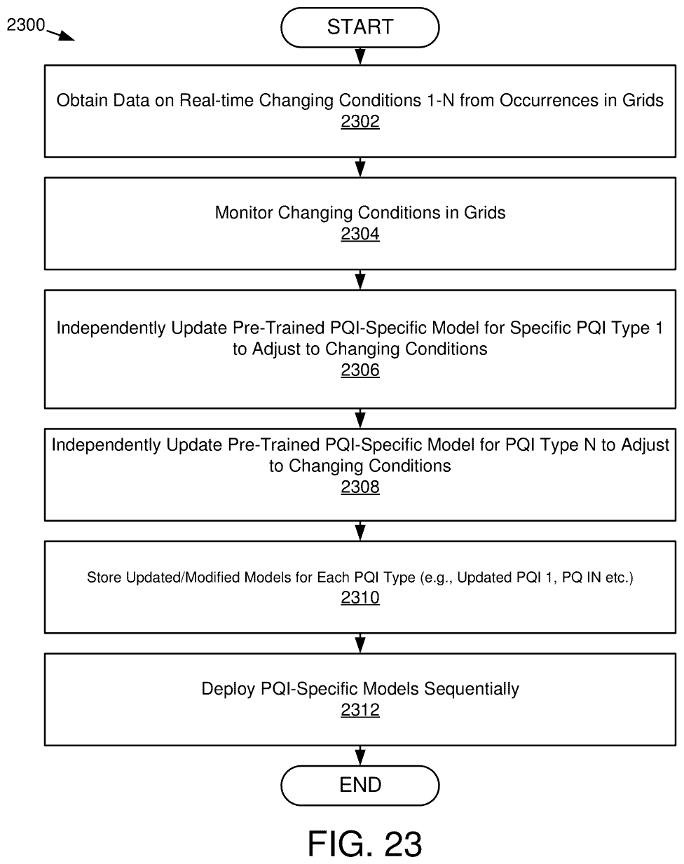

FIG. 23 is a flow chart illustrating dynamically and independently updating the models on new data to adjust to the constantly changing conditions of the grid. This advantageously avoids retraining or modifying the all the models on all the different types of power quality issues, for efficiency and rapid adaptation.

The process designated generally by reference numeral 2300 begins and proceeds to block 2302, which includes (represents) one or more operations for obtaining data on real-time changing conditions 1−N from occurrences in grids. The process 2300 proceeds to the next block of operations designated by the reference numeral 2304, including one or more operations monitoring the changing conditions in the grids. In some implementations, as described above, the grids may be monitored by sensors or other hardware. The process 2300 proceeds to the next block of operations designated by the reference numeral 2306, including one or more operations for independently update the pre-trained PQI-specific models for specific PQI types, for example, PQI 1, to adjust for changing conditions. The PQI 1 may be voltage, current, or the any of the others described in this disclosure or known to those skilled in the art. The process 2300 proceeds to the next block of operations designated by reference numeral 2308, including one or more operations for independently updating pre-trained PQI-specific models for different PQI types (denoted by the letter “N” to designate any number of different types of PQI issues. The process 2300 proceeds to the next block of operations designated by the reference numeral 2310, including one or more operations storing the updated or modified models for each PQI type, for example, updated PQI 1, PQI N, and so on. The process 2300 proceeds to the next block of operations, including one or more operations for deploying PQI-specific models sequentially.

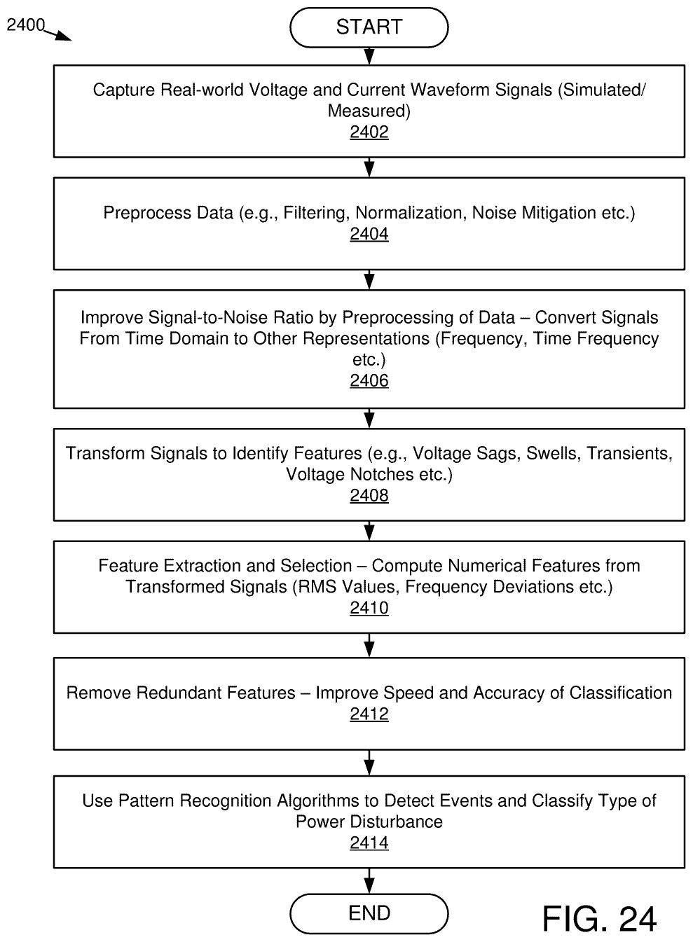

Referring now to FIG. 24, the process for detecting power quality issues (PQIs) designated generally by reference numeral 2400 begins and proceeds to the block 2402 including one or more operations for capturing real-world voltage and current waveform signals that may be simulated or measured. The process 2400 proceeds to the next block 2404 including one or more operations for preprocessing data (from raw data received from the various data streams). In some implementations, the raw data may be filtered, normalized, or addressed for noise mitigation. The process 2400 proceeds to the next block 2406 including one or more operations for improving signal-to-noise ratio during preprocessing of data, by converting signals from the time domain to other representations, for example frequency, time frequency etc. The process 2400 proceeds to the next block 2408 including one or more operations for transforming signals to identify features, for example, voltage sags, swells, transients, voltage notches etc. The process 2400 proceeds to the next block 2410 including one or more operations for extracting and selecting features, by computing numerical features from transformed signals. In some implementations, the numerical features may be RMS values, frequency deviations etc. The process 2400 proceeds to the next block 2412 including one or more operations for removing redundant features, for example, improving speed and accuracy of the classifications. The process 2400 proceeds to the next block 2414 including one or more operations for using pattern recognition algorithms to detect events and classify the type of power disturbance (or power quality issue).

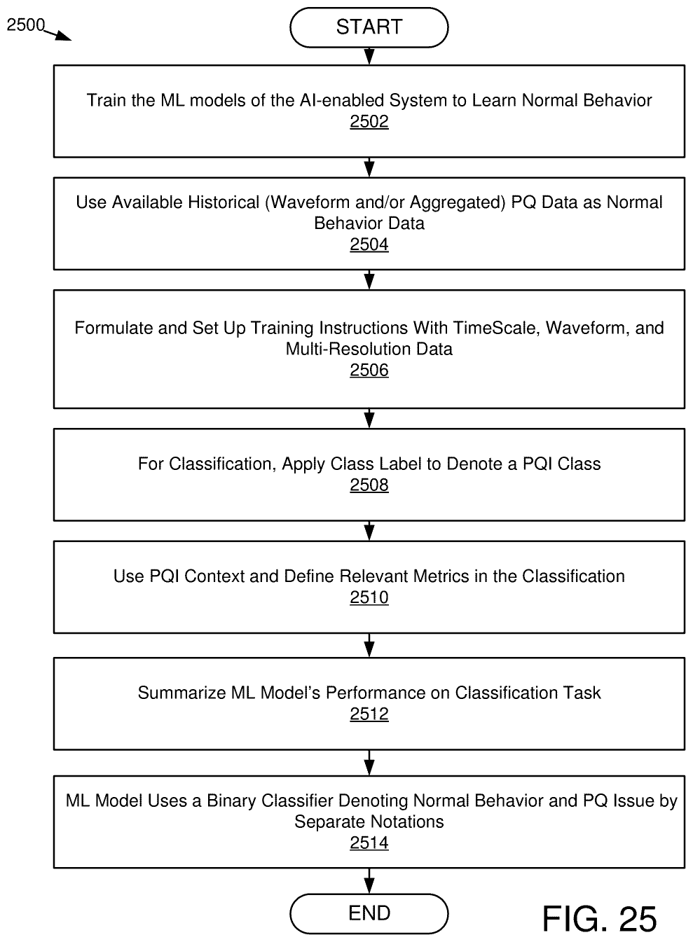

FIG. 25 is a flow chart illustrating the process of training the ML models to detect power quality issues by continuous updating of model distribution over time and dynamic changes of the thresholds of the features. Referring now to FIG. 25, the process of training the ML models of the Intelligent AI-enabled system 114 is designated generally by reference numeral 2500. The process 2500 begins and proceeds to the block 2502 including one or more operations for training the ML models of the Intelligent AI-enabled system 114 to learn normal behavior. The process 2500 proceeds to the next block 2504 including one or more operations for using available historical (e.g., waveform and/or aggregated) power quality (PQ) data as normal behavior data. The process 2500 proceeds to the next block 2506 including one or more operations for formulating and setting up training instructions with timescale, waveform, and multi-resolution data. The process 2500 proceeds to the next block 2508 including one or more operations for classifying, by applying class labels to denote a power quality issue (PQI) class. The process 2500 proceeds to the next block 2510 including one or more operations for using power quality issue (PQI) context to define relevant metrics in the classification. The process 2500 proceeds to the next block 2512 including one or more operations for summarizing the ML model's performance on classification tasks. The process 2500 proceeds to the next block 2514 including one or more operations for using a binary classifier for the ML model to denote normal behavior from a power quality issue by separate notations.

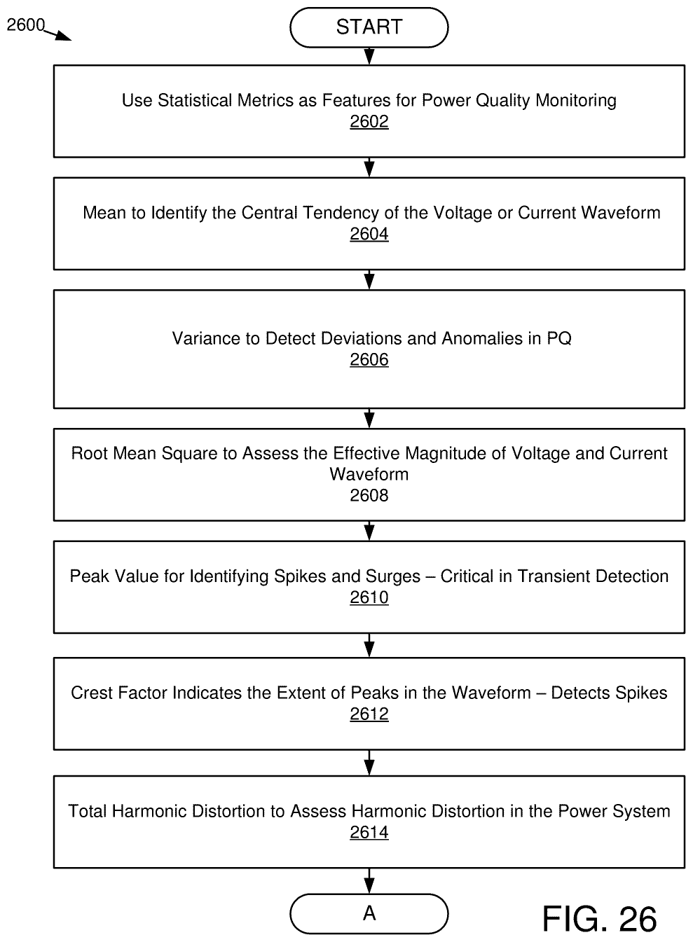

FIG. 26 is a flow chart illustrating the process for using different statistical metrics as features for monitoring power quality issues (PQIs). The table below indicates the common statistical metrics that may be used as features for monitoring power quality (PQ).

TABLE
Common statistical metrics used as features in PQ monitoring.

| Metric Name | Definition | Advantages |
|---|---|---|
| Mean (μ) | The average value of the signal over a period. | Identifies the central |
| | | tendency of the voltage or |
| | | current waveform. |
| Variance (σ²) | Measures the spread of data points from the | Helps in detecting |
| | mean. | deviations and anomalies |
| | | in power quality. |
| Root Mean Square | The square root of the arithmetic mean of the | Key in assessing the |
| (RMS, Xᵣₘₛ) | squares of the signal values. | effective magnitude of |
| | | voltage and current |
| | | waveform. |
| Peak Value (Xₚₑₐₖ) | The maximum absolute value of the signal | Useful for identifying |
| | within a period. | spikes and surges, critical |
| | | in transient detection. |
| Crest Factor (CF) | The ratio of the peak value to the RMS value, | Indicates the extent of |
| | $CF = \frac{{X}_{peak}}{{X}_{rms}} .$ | peaks in the waveform; helps detect spikes. |
| Total Harmonic | A measure of the harmonic distortion present | Essential for assessing |
| Distortion (THD) | and is defined as the ratio of the sum of the | harmonie distortion in the |
| | powers of all harmonic components to the | power system. |
| | power of the fundamental frequency. | |
| Skewness (γ₁) | A measure of the asymmetry of the probability | Indicates the symmetry of |
| | distribution of a real-valued random variable | the signal, helping in |
| | about its mean. | identifying waveform |
| | | distortions. |
| Kurtosis (γ₂) | Describes the shape of the probability | Useful for detecting |
| | distribution (tailedness). | outliers and transient |
| | | disturbances in power |
| | | quality. |
| Waveform Factor (WF) | The ratio of RMS value to the mean of the | Helps in characterizing the |
| | $absolute values of the signal , WF = \frac{{X}_{rms}}{{μ}_{\vert x \vert}} .$ | waveform shape, distinguishing between |
| | | sinusoidal and |
| | | non-sinusoidal forms. |
| Form Factor (FF) | The ratio of the RMS value to the average of | Useful in determining the |
| | $the absolute values , FF = \frac{{X}_{rms}}{{μ}_{x}} .$ | shape of the AC waveform in power quality studies. |
| Impulse Factor (IF) | The ratio of the peak value to the mean of the | Identifies high impulse |
| | $absolute values , IF = \frac{{X}_{peak}}{{μ}_{\vert x \vert}} .$ | noises, useful in transient and surge detection. |

The process is designated generally by reference numeral 2600. The process 2600 begins and proceeds to block 2602 including one or more operations for using statistical metrics as features for monitoring for power quality issues (PQIs). The process 2600 proceeds to the next block 2604 including one or more operations that use the mean to identify the central tendency of the voltage or current waveform. The process 2600 proceeds to the next block 2606 including one or more operations that use the variance to detect deviations and anomalies in power quality. The process 2600 proceeds to the next block 2608 including one or more operations that use the root mean square to assess the effective magnitude of voltage and current waveform. The process 2600 proceeds to the next block 2610 including one or more operations that use the peak value to identify spikes and surges, which are critical in transient detection. The process 2600 proceeds to the next block 2612 including one or more operations that use the crest factor to indicate the extent of peaks in the waveform, which detects spikes. The process 2600 proceeds to the next block 2614 including one or more operations that use the total harmonic distortion to assess harmonic distortion in the power system being monitored.

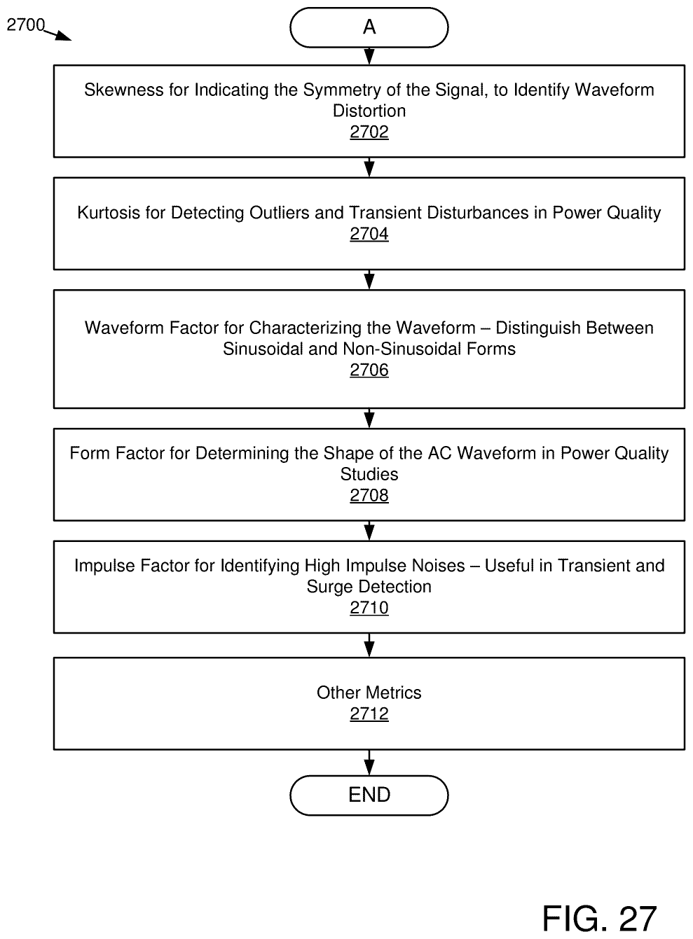

FIG. 27 is a flow chart illustrating the process 2600 illustrated in FIG. 26 continued via connector “A.” The process in FIG. 27 is illustrated generally by reference numeral 2700 and continues via connector “A.” The process 2700 proceeds to the block 2702 including one or more operations that use “skewness” to indicate the symmetry of the signal, to identify waveform distortion. The process 2700 proceeds to the next block 2704 including one or more operations for using “kurtosis” to detect outliers and transient disturbances in power quality. The process 2700 proceeds to the next block 2706 including one or more operations for using waveform factors for characterizing the waveform to distinguish between sinusoidal and non-sinusoidal waveforms. The process 2700 proceeds to the next block 2708 including one or more operations for using form factors for determining the shape of the AC waveform in power quality studies (or surveillance). The process 2700 proceeds to the next block 2710 including one or more operations for using an impulse factor for identifying high impulse noises, which are useful in transient and surge detection.

Throughout this disclosure, identical reference characters and descriptions indicate similar, but not necessarily identical, elements. While the exemplary embodiments described herein are susceptible to various modifications and alternative forms, specific embodiments have been shown by way of example in the appendices and will be described in detail herein. However, the exemplary embodiments described herein are not intended to be limited to the particular forms disclosed. Rather, the present disclosure covers all modifications, equivalents, and alternatives falling within this disclosure.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for case of use, the terms “including” and “having” (and their derivatives), as used in the specification and claims, are interchangeable with and have the same meaning as the word “comprising.”

What is claimed is:

1. A power quality issue detection and characterization system, comprising:
memory storing executable code;
a processor coupled to the memory to execute actions by the executable code;
an interface coupled to the memory and processor for providing power monitoring input data acquired from a plurality of different power sources associated with a particular facility or equipment; and
a plurality of classified agents dedicated to different types of power quality issues, the plurality of classified agents coupled to the memory and the interface and configured by the processor executing the executable code to identify instances of a plurality of different types of power quality issues from the power monitoring input data and produce responsive output data signals that reflect a specific type of power quality issue occurring in the particular facility or equipment to generate an alert signal and prevent a disturbance at the particular facility or equipment.

2. The power quality issue detection and characterization system of claim 1, wherein the memory further comprises a repository of data relevant to detecting the type of power quality issue occurring at the particular facility or equipment, including historical data.

3. The power quality issue detection and characterization system of claim 1, further comprising:
a power quality issue event handler coupled to the interface, wherein the power quality issue event handler creates a log responsive to receiving the alert and escalates the alert to an operator at the particular facility or associated with the equipment.

4. The power quality issue detection and characterization system of claim 3, further comprising:
an anomaly score generator coupled to the interface to designate anomaly scores for feature vectors associated with the particular facility or equipment collected over a given window of time.

5. The power quality issue detection and characterization system of claim 1, wherein the plurality of classified agents are independently trained and deployed sequentially.

6. The power quality issue detection and characterization system of claim 5, wherein the diverse data streams applied for training use multi-modal including waveform and non waveform data.

7. The power quality issue detection and characterization system of claim 1, wherein one or more extracted features from the input data is fed into a Bayesian classifier, which is trained to recognize and differentiate between the various extracted features to identify the cause of the type of power quality issue causing a disruption at the particular facility or with the equipment.

8. The power quality issue detection and characterization system of claim 1, further comprising:
a model combining a neural network with a multi-stage normalizing flow to model conditional probability distributions.

9. The power quality issue detection and characterization system of claim 1, further comprising:
a probabilistic classifier trained by data streams that include at least voltage sags, swells, transients, and voltage notches identified in real-time signal streams.

10. The power quality issue detection and characterization system of claim 1, further comprising:
an alarm-rate decision matrix configured to provide input by at least one of expert systems, human experts, engineers, and operators.

11. A method for detecting and characterizing power quality issues, comprising:
storing in a memory, power monitoring data on a plurality of different types of power quality issues, and executable code for executing actions by a processor;
providing power monitoring data acquired from a plurality of different power sources associated with a particular facility or equipment; and
creating a plurality of classified agents dedicated to a plurality of different types of power quality issues, the plurality of classified agents configured by the processor executing the executable code to identify instances of power quality issues of a particular type that occur in real-time at the particular facility or equipment and produce output data reflecting a critical power quality issue at the particular facility or equipment to generate an alert signal and prevent a disturbance at the particular facility or with the equipment, by further:
training a normalizing flow model on feature vectors derived from normal-state high frequency waveform data to learn a probability distribution of normal behavior;
calculating a negative log-likelihood of a new feature vector against said probability distribution;
determining an anomaly score for the new feature based on an empirical cumulative distribution function of a plurality of negative log-likelihood values.

12. The method for detecting and characterizing power quality issues of claim 11, wherein the alert signal is generated when it passes the alert threshold.

13. The method for detecting and characterizing power quality issues of claim 11, further comprising:
creating a log responsive to generating the alert by a power quality issue event handler coupled to the processor and escalating the alert to an operator at the particular facility or associated with the equipment.

14. The method for detecting and characterizing power quality issues of claim 11, further comprising:
generating an anomaly score, by an action by the processor, to designate anomaly scores for features vectors associated with the particular facility or equipment collected over a given window of time.

15. The method for detecting and characterizing power quality issues of claim 14, wherein the plurality of classified agents are trained independently and deployed sequentially.

16. The method for detecting and characterizing power quality issues of claim 11, wherein the data streams include data on signals relating to voltage, current, equipment, operational state, vibration and acoustics, local and component-level temperature, upstream power quality data and external data.

17. The method for detecting and characterizing power quality issues of claim 11, wherein a plurality of features from the input data is provided to a probabilistic (a Bayesian or a data-driven similarity score-based) classifier, wherein the decision tree-based classifier is trained to recognize and differentiate between the plurality of features to identify the cause of the power quality issue causing a disruption at the particular facility or with the equipment.

18. The method for detecting and characterizing power quality issues of claim 11, further comprising:
providing a probabilistic classifier using normalizing flows trained by data streams that identify normal behavior and data collected over time from power quality issues.

19. The method for detecting and characterizing power quality issues of claim 11, wherein the data streams include at least voltage sags, swells, transients, and voltage notches identified in real-time signal streams.

20. The method for detecting and characterizing power quality issues of claim 11, further comprising:
using an alarm-rate decision matrix to provide input by at least one of an expert system, a human expert, an engineer, and an operator.
